(19) United States
(12) Patent Application Publication
(10) Pub. No.: US 2014/0170918 A1
(43) Pub. Date: Jun. 19, 2014

(54) DURABLE FIBER WEBS

(71) Applicant: HOLLINGSWORTH & VOSE COMPANY, East Walpole, MA (US)

(72) Inventors: Richard O. Angus, JR., Moosup, CT (US); Cameron Thomson, Charleston, SC (US); Sneha Swaminathan, Nashua, NH (US)

(73) Assignee: Hollingsworth & Vose Company, East Walpole, MA (US)

(21) Appl. No.: 13/738,875

(22) Filed: Jan. 10, 2013

Related U.S. Application Data
(63) Continuation-in-part of application No. 13/715,401, filed on Dec. 14, 2012, now abandoned.

(51) Int. Cl. C03C 25/32

(52) U.S. Cl. CPC C03C 25/32
USPC 442/175; 442/180; 442/174

(57) ABSTRACT

Fiber webs that may be coated and used in filter media are provided. In some embodiments, the fiber web is a non-woven web that is coated with a resin including at least two components (e.g., a first component and a second component) that may react with one another to form a copolymer. In some embodiments, the coated fiber web may be sufficiently self-supporting, durable, and strong, such that filter media and/or elements formed of the web do not require additional support structures (e.g., a scrim).

### RELATED APPLICATIONS

This application is a continuation-in-part of U.S. application Ser. No. 13/715,401, filed Dec. 14, 2012, which is incorporated herein by reference in its entirety.

### FIELD OF INVENTION

The present embodiments relate generally to fiber webs, and specifically, to fiber webs that are coated with a resin.

### BACKGROUND

Filter elements can be used to remove contamination in a variety of applications. Such elements can include a filter media which may be formed of a web of fibers. The fiber web provides a porous structure that permits fluid (e.g., gas, liquid) to flow through the media. Contaminant particles (e.g., dust particles, soot particles) contained within the fluid may be trapped on or in the fiber web. Depending on the application, the filter media may be designed to have different performance characteristics.

In some applications, fiber webs may be coated with a resin. Although many coated fiber webs exist, improvements in the mechanical properties of the fiber web (e.g., stiffness, strength, and elongation) would be beneficial.

### SUMMARY OF THE INVENTION

Fiber webs that are coated with a resin, and related components, systems, and methods associated therewith are provided. The subject matter of this application involves, in some cases, interrelated products, alternative solutions to a particular problem, and/or a plurality of different uses of structures and compositions.

In one set of embodiments, a series of methods is provided. In one embodiment, a method comprises providing a non-woven web comprising a plurality of glass fibers, and coating at least a portion of the non-woven web with a resin comprising a first component and a second component. The first component is a polymer having a glass transition temperature of less than or equal to about 60° C. The method also involves reacting the first component with the second component.

In another embodiment, a method comprises providing a non-woven web comprising a plurality of glass fibers, and coating at least a portion of the non-woven web with a resin comprising a first component and a second component. The first component is a polymer having a number average molecular weight of greater than or equal to about 3,000 g/mol. The method also involves reacting the first component with the second component.

In another embodiment, a method comprises providing a non-woven web comprising a plurality of glass fibers, coating at least a portion of the non-woven web with a resin comprising a first component and a second component, and reacting the first component with the second component. The first component is selected from the group consisting of polyacrylates, polyurethanes, polycarbonates, saturated polyesters, unsaturated polyesters, polyterpenes, furan polymers, polyfurfural alcohol, polyamides, polyimides, polyamidimides, polyamidoamines, copolymers thereof, and combinations thereof.

In another set of embodiments, a series of articles are provided. In one embodiment, an article comprises a non-woven web comprising a plurality of glass fibers and a coating that coats at least a portion of the non-woven web. The coating comprises a reaction product of a first component and a second component. The first component is a polymer having a glass transition temperature of less than or equal to about 60° C.

In another embodiment, an article comprises a non-woven web comprising a plurality of glass fiber and a coating that coats at least a portion of the non-woven web. The coating comprises a reaction product of a first component and a second component. The first component is a linear polymer having a number average molecular weight of greater than 3,000 g/mol.

In another embodiment, an article comprises a non-woven web comprising a plurality of glass fibers and a coating that coats at least a portion of the non-woven web, wherein the coating comprises a reaction product of a first component and a second component. The first component is a selected from the group consisting of polyacrylates, polyurethanes, polycarbonates, saturated polyesters, unsaturated polyesters, polyterpenes, furan polymers, polyfurfural alcohol, polyamides, polyimides, polyamidimides, polyamidoamines, copolymers thereof, and combinations thereof.

In another embodiment, an article comprises a non-woven web comprising a plurality of glass fibers, wherein the non-woven web has a tensile strength in the machine direction of greater than or equal to about 2 lb/in and less than or equal to about 150 lb/in, and a Mullen burst strength of greater than or equal to about 10 psi and less than or equal to about 250 psi. The non-woven web optionally includes 0-1 wt % thermoplastic binder fibers and 0-2 wt % fibrillated fibers.

In another embodiment, an article comprises a non-woven web comprising a plurality of glass fibers, wherein the non-woven web has a dry elongation at break in the machine direction of greater than or equal to about 2% and less than or equal to about 50%. The non-woven web optionally includes 0-2 wt % of thermoplastic binder fibers and 0-2 wt % fibrillated fibers.

In another embodiment, a hydraulic filter element is provided. The hydraulic filter element comprises a non-woven web comprising a plurality of glass fibers. The non-woven web optionally includes 0-2 wt % of thermoplastic binder fibers and 0-2 wt % of fibrillated fibers. The hydraulic filter element is free of a scrim layer.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of examples with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic diagram showing a cross section of a fiber web including a plurality of fibers according to one set of embodiments;

FIG. 1B is a schematic diagram showing a cross section of a fiber web including fibers that are partially coated with a resin according to one set of embodiments;

FIG. 1C is a schematic diagram showing a cross section of a fiber web in which substantially all of the fibers are coated with a resin according to one set of embodiments.

### DETAILED DESCRIPTION

Fiber webs that may be coated and used in filter media are provided. In some embodiments, the fiber web is a non-woven web coated with a resin including at least two components that may react with one another to form a copolymer. A first component may impart, for example, flexibility (e.g., elongation) and/or strength to the coated fiber web, whereas a second component may impart stiffness to the web, amongst other properties. The respective characteristics and amounts of the components in the resin may be selected to tailor the mechanical properties of the fiber web. In some instances, a relatively high weight percentage of resin in the coated fiber web may be used to impart enhanced mechanical properties (e.g., strength) without adversely affecting filtration performance (e.g., air permeability). In some embodiments, the coated fiber web may be sufficiently self-supporting, durable, and strong, such that filter media and/or elements formed of the webs do not require additional support structures (e.g., a scrim).

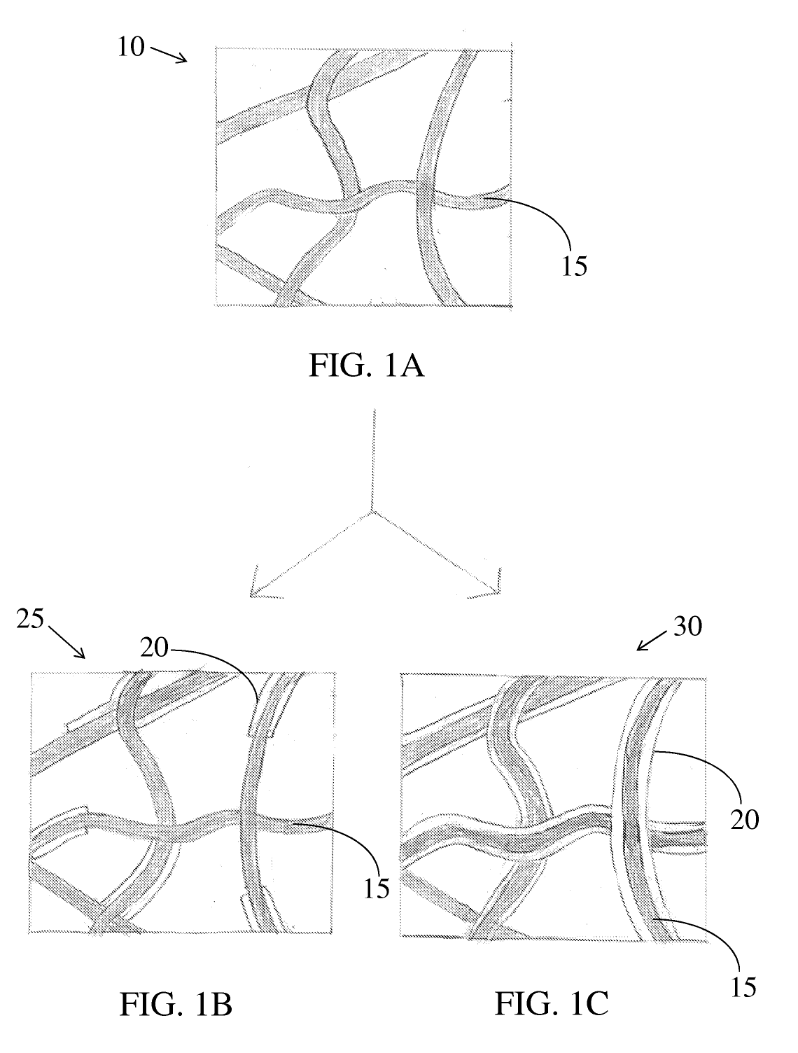

An example of a fiber web that is coated with a resin is shown in FIGS. 1A-1C. As shown illustratively in FIG. 1A, a fiber web 10, shown in cross-section, may include a plurality of fibers 15. All or portions of the fiber web may be coated with a resin including at least two components (e.g., a first component and a second component) as illustrated in FIGS. 1B-1C. After coating the fiber web with the resin and removing excess resin from the fiber web, the resin may be cured. For instance, in some embodiments, a component in the resin may undergo a chemical reaction with itself and/or another component to form a reaction product (e.g., a copolymer, a crosslinked network, a cured network). In certain embodiments, the at least two components of the resin may react with one another to form a copolymer, as described in more detail below.

The extent of the coating may vary. For example, in one embodiment a coating may be formed on a surface of the fiber web. In some embodiments, a resin may be applied to the fiber web to produce a coating on at least a portion of the fibers in the interior of the fiber web (i.e., through the thickness of the fiber web). In certain embodiments, substantially all of the fibers of the fiber web may be coated with the resin, as illustrated in FIG. 1C. However, in some embodiments, not all fibers are coated, e.g., as illustrated in FIG. 1B. In some embodiments, the coated fiber webs 25 and 30, shown in FIGS. 1B and 1C, respectively, may be used as filter media and may have enhanced mechanical properties as described herein.

As described herein, a fiber web may be coated with a resin (e.g., a pre-cured resin) that includes at least two components (e.g., a first component and a second component). The components in the resin may undergo a chemical reaction with one another (e.g., upon curing) to form a reaction product. Additionally, in some cases, a component in the resin may react with itself. For instance, a component in the form of a monomer (e.g., an epoxy monomer) may polymerize to form a homopolymer (e.g., polyepoxide). In some cases, a component may react with another component in the resin, e.g., to form a copolymer. For example, a first monomer (e.g., an epoxy monomer) in the resin may react with another component in the resin, such as a second monomer or a polymer (e.g., a copolyester), to form a branched polymer, a linear polymer, a copolymer, a crosslinked network, or combinations thereof.

In some embodiments, a component in the resin may undergo more than one chemical reaction. For instance, a component in the resin may react with itself and with a second component in the resin. In one example, a monomer (e.g., an epoxy monomer) in the resin may react with itself to form an oligomer or polymer, which may react with a polymer in the resin to form a copolymer. In some cases, more than one chemical reaction may occur simultaneously and/or sequentially. In some embodiments, after the formation of a reaction product in the resin (e.g., by reaction of a first component with itself, or by reaction of a first component with a second component), the reaction product may undergo a chemical reaction. For example, a copolymer (e.g., a reaction product of a first component such as a copolyester and second component such as an epoxy monomer) may react with a polymer (e.g., a third component, or more of the first component) to form a polymer network (e.g., a cured or crosslinked network). In certain cases, a reaction product in the resin may react with itself to form a longer chained polymer that may be branched or unbranched. For example, an oligomer (e.g., a reaction product of an epoxy monomer) may react with itself to form a polymer. A reaction product may also react with another reaction product in the resin. For instance, a first polymer (e.g., a reaction product of epoxy) may react with a second polymer (e.g., a reaction product of a polymer and a monomer) to form a copolymer.

In some embodiments, a reaction product in the resin may undergo more than one chemical reaction. For instance, a reaction product in the coating may react with itself and with another component in the coating. In one example, a first reaction product (e.g., a polymer such as a polyepoxide) may react with a second polymer in the resin to form a second reaction product (e.g., a copolymer). The first reaction product may optionally undergo another reaction, e.g., crosslinking with other first reaction products or second reaction products in the resin. When more than one chemical reaction takes place, the reactions may occur simultaneously and/or sequentially.

In other embodiments, a first component in the resin may be designed to react with itself but not another component (e.g., a second component) in the resin. Additionally, a second component may be designed to react with itself and not with the first component. Such components can be designed by tailoring the functional groups of the components as known to those of ordinary skill in the art. The two types of polymer chains formed may be intertwined with one another, but not covalently coupled, in the resulting coating.

In some embodiments, a component and/or reaction product in the resin may react to form a particular type of copolymer. Exemplary types of copolymers include alternating copolymers, periodic copolymers, random copolymers, dendrimer, terpolymers, quaterpolymers, graft copolymers, linear copolymer, and block copolymers.

In some embodiments, a fiber web coated with a resin that includes at least two components as described herein may have enhanced mechanical and/or filtration properties compared to a fiber web coated with a resin that includes only a single component (e.g., a first component or a second component). In one example, a fiber web coated with a resin that includes a first component (e.g., a polymer) and a second component (e.g., an epoxy) may be stronger and/or more flexible (e.g., have higher elongation) than a fiber web coated with a resin that only includes one of the components (e.g., an epoxy resin). Other advantages are described herein.

It should be appreciated that while much of the description herein pertains to a resin containing first and second components, in some embodiments a resin may include additional reactive components (e.g., a third component, a fourth component, etc.). Each of the additional components may have one or more characteristics of a “first component” or a “second component” as described herein. In such instances, the resin may include more than one different type of “first components”, and/or more than one different type of “second components”. Other configurations are also possible.

As described herein, a resin that forms a coating on a fiber web may include at least a first component. The first component may be a reactive entity that includes one or more reactive functional groups which can allow the first component to undergo a chemical reaction to form a larger molecule (e.g., a polymer). Non-limiting examples of reactive functional groups include hydroxyl groups, carboxyl groups, amino groups, mercaptan groups, acrylate groups, vinyl groups, nitrile groups, isocyanate groups, and ester groups.

In some embodiments, the first component is a reactive polymer (e.g., a linear polymer, a copolymer). The polymer may be a particular type (e.g., polyester) or in a particular class (e.g., thermoplastic). Non-limiting examples of types of polymers that may be suitable as a first component include polyethers, polyarylethers, polyalkyethers, polysulfone, polyarylsulfone, polyvinylchloride, polyether ether ketones, polyether ketones, polyethersulfones, polyolefins, rubbers, polystyrenes, styrene acrylates, styrene maleic anhydrides, polyvinyl alcohols, polyvinyl acetates, polyvinyl alcohol esters, polyvinyl amines and ammonium salts of polyvinylamines, polyvinyl amides and partially hydrolyzed polyvinylamides and ammonium salts of partially hydrolyzed vinylamides, polyacrylonitriles, polyparalenes, polyphenylenes, polyglycolides, poly(lactic-co-glycolic acid), polylactic acid, polycaprolactam, poly(glycolide-co-caprolactone), poly (glycolide-co-trimethylene carbonate), polysiloxanes, polyarylates, polyaminoacids, polylactams, polyhydantoins, polyketones, polyureas, polystyrene sulfonates, lignins, polyphosphazines, polyethylene chlorinates, polyetherimide, cellulose acetate, carboxymethyl cellulose, alkyds, polyacrylates, polyurethanes, polycarbonates, saturated polyesters, unsaturated polyesters, polyterpenes, furan polymers, polyfurfural alcohol, polyamides, polyimides, polyamidimides, polyamidoamines, copolymers thereof, and combinations thereof. Exemplary classes of polymers include thermoplastics and thermosets. Other types and classes of polymers are also possible.

In some embodiments, the first component is a copolymer. The copolymer may be, for example, an alternating copolymer, a periodic copolymer, a random copolymer, a dendrimer, a terpolymer, a quaterpolymer, a graft copolymer, a linear copolymer, or a block copolymer.

In some embodiments, the first component (e.g., a polymer) may have certain properties, such as number of repeat units (n), number average molecular weight (Mₙ), glass transition temperature (T_{g}), hydroxyl (OH) number, and/or acid number. In certain embodiments, the number of repeat units and number average molecular weight may be selected to impart desirable properties (e.g., enhanced solubility in the resin or resin solution, add flexibility and/or strength to the fiber web). For example, a first component with a relatively high number of repeat units and Mₙ may, in some embodiments, produce a more flexible and stronger (e.g., less brittle) coating than a first component with a relatively low number of repeat units and/or Mₙ. The glass transition temperature of the first component may be selected to enhance certain mechanical properties of the fiber web, such as elongation, strength, flexibility, and/or resistance to deformation.

In certain embodiments in which the first component (e.g., a polymer) includes hydroxyl (—OH) groups and acid groups, the OH number and acid number may be selected to impart reactive functionality for a chemical reaction. In some instances, the OH number and acid number of the first component may influence the number of chemical reactions that the first component (e.g., polymer) undergoes and/or the type of reaction products (e.g., a long chain copolymer, crosslinked network) that are formed. In turn, the number of chemical reactions and the type of reaction products in the coating may influence the mechanical properties of the fiber web. In one example, a first component with a relatively low OH number and/or acid number may undergo fewer chemical reactions than a first component with a relatively high OH number and/or acid number. A first component with a relatively low OH number and/or acid number may enhance the flexibility of the fiber web, whereas a first component with a relatively high OH number and/or acid number may produce a relatively more brittle coating on the fiber web.

In some instance, the first component (e.g., a polymer) may be selected based on a single property. For example, the first component may be selected based on its glass transition temperature. In other instances, the first component may be selected based on more than one property (e.g., T_{g}, Mₙ, and OH number). In certain embodiments, the criteria for selecting a first component may vary based on certain factors, such as other components in the resin and the intended application of the fiber web.

In some embodiments, the first component may have a certain range of repeat units. For instance, the number of repeat units in the first component may be greater than or equal to about 20, greater than or equal to about 50, greater than or equal to about 100, greater than or equal to about 200, greater than or equal to about 300, or greater than or equal to about 400. In some instances, the number of repeat units in the first component may be less than or equal to about 500, less than or equal to about 400, less than or equal to about 300, less than or equal to about 200, less than or equal to about 100, or less than or equal to about 50. Combinations of the above-referenced ranges are also possible (e.g., greater than or equal to about 20 and less than or equal to about 400). Other values of the number of repeat units in the first component are also possible. The number of repeat units may be determined using gel permeation chromatography (GPC), nuclear magnetic resonance (NMR), or may be obtained from a manufacturer's specifications.

In some embodiments, the first component may be selected based on its number average molecular weight. For instance, the number average molecular weight of the first component may be greater than or equal to about 1,000 g/mol, greater than or equal to about 3,000 g/mol, greater than or equal to about 5,000 g/mol, greater than or equal to about 10,000 g/mol, greater than or equal to about 15,000 g/mol, greater than or equal to about 20,000 g/mol, about 30,000 g/mol, or greater than or equal to about 40,000 g/mol. In some instances, the number average molecular weight of the first component may be less than or equal to about 50,000 g/mol, less than or equal to about 40,000 g/mol, less than or equal to about 30,000 g/mol, less than or equal to about 25,000 g/mol, less than or equal to about 20,000 g/mol, less than or equal to about 15,000 g/mol, less than or equal to about 10,000 g/mol, or less than or equal to about 5,000 g/mol. Combinations of the above-referenced ranges are also possible (e.g., greater than or equal to about 3,000 g/mol and less than or equal to about 40,000 g/mol). Other values of the number average molecular weight of the first component are also possible. The number average molecular weight may be determined using gel permeation chromatography (GPC), nuclear magnetic resonance spectrometry (NMR), laser light scattering, intrinsic viscosity, vapor pressure osmometry, small angle neutron scattering, laser desorption ionization mass spectrometry, matrix assisted laser desorption ionization mass spectrometry (MALDI MS), electrospray mass spectrometry or may be obtained from a manufacturer's specifications. Unless otherwise indicated the values of number average molecular weight described herein are determined by gel permeation chromatography (GPC).

In some embodiments, the first component may be selected based on its glass transition temperature (T_{g}). For instance, in some embodiments, the glass transition temperature of the first component may be greater than or equal to about −30° C., greater than or equal to about −15° C., greater than or equal to about 0° C., greater than or equal to about 15° C., greater than or equal to about 30° C., greater than or equal to about 45° C., greater than or equal to about 60° C., greater than or equal to about 75° C., or greater than or equal to about 90° C. In some instances, the glass transition temperature of the first component may be less than or equal to about 120° C., less than or equal to about 100° C., less than or equal to about 80° C., less than or equal to about 60° C., less than or equal to about 40° C., less than or equal to about 20° C., less than or equal to about 0° C., or less than or equal to about −20° C. Combinations of the above-referenced ranges are also possible (e.g., greater than or equal to about 15° C. and less than or equal to about 80° C.). Other values of glass transition temperature of the first component are also possible. The glass transition temperature of the first component may be determined using differential scanning calorimetry (DSC), thermomechanical analysis (TMA), dynamic mechanical analysis (DMA), or may be obtained from a manufacturer's specifications. Unless indicated otherwise, the values of glass transition temperature described herein are determined by differential scanning calorimetry (DSC).

In some embodiments, the first component may be selected based on its hydroxyl (OH) number. The OH number is the number of milligrams of potassium hydroxide equivalent, in number of moles, to the hydroxyl content in one gram of the component. The OH number of the first component may be, for example, greater than or equal to about 0, greater than or equal to about 2, greater than or equal to about 5, greater than or equal to about 10, greater than or equal to about 30, greater than or equal to about 50, greater than or equal to about 70, or greater than or equal to about 90. In some instances, the OH number of the first component may be less than or equal to about 100, less than or equal to about 80, less than or equal to about 60, less than or equal to about 40, less than or equal to about 20, or less than or equal to about 10. Combinations of the above-referenced ranges are also possible (e.g., greater than or equal to about 2 and less than or equal to about 60). Other values of the OH number of the first component are also possible. The OH number may be determined by acetylating the hydroxyls with excess acetic anhydride and titrating the acetic acid remaining after by the acetylation reaction.

In some embodiments, the first component may be selected based on its acid number. The acid number is the number of milligrams of potassium hydroxide equivalent, in number of moles, to the free acid content in one gram of the component. The acid number of the first component may be, for example, greater than or equal to about 0, greater than or equal to about 1, greater than or equal to about 3, greater than or equal to about 5, greater than or equal to about 10, greater than or equal to about 15, or greater than or equal to about 20. In some instances, the acid number of the first component may be less than or equal to about 25, less than or equal to about 20, less than or equal to about 15, less than or equal to about 10, less than or equal to about 5, or less than or equal to about 3. Combinations of the above-referenced ranges are also possible (e.g., greater than or equal to about 0 and less than or equal to about 10). Other values of the acid number of the first component are also possible. The acid number may be determined by titrating the acid to the equivalence point with potassium hydroxide.

In some embodiments, the weight percentage of the first component in the resin may be selected as desired. For instance, the weight percentage of the first component in the resin may be greater than or equal to about 1 wt %, greater than or equal to about 15 wt %, greater than or equal to about 20 wt %, greater than or equal to about 40 wt %, greater than or equal to about 55 wt %, greater than or equal to about 70 wt %, or greater than or equal to about 85 wt %. In some instances, the weight percentage of the first component in the resin may be less than or equal to about 99 wt %, less than or equal to about 90 wt %, less than or equal to about 75 wt %, less than or equal to about 60 wt %, less than or equal to about 45 wt %, less than or equal to about 30 wt %, or less than or equal to about 15 wt %. Combinations of the above-referenced ranges are also possible (e.g., greater than or equal to about 20 wt % and less than or equal to about 99 wt %). Other values of weight percentage of the first component in the resin are also possible. The weight percentage of the first component in the resin is based on the dry resin solids and can be determined prior to coating the fiber web.

As described herein, a resin that forms a coating on a fiber web may include a second component. The second component may be a reactive entity such as a polymerizable molecule. In some embodiments, the second component may have fewer than 5 to 20 repeat units (e.g., an oligomer) or no repeat units (e.g., a monomer). For example, the second component may include less than or equal to 20, less than or equal to 15, less than or equal to 10, less than or equal to 5, less than or equal to 3, or less than or equal to 2 repeat units. The second component may include one or more reactive functional groups which can allow the second component to undergo a chemical reaction to form a larger molecule (e.g., a polymer). Non-limiting examples of reactive functional groups include hydroxyl groups, carboxyl groups, amino groups, mercaptan groups, acrylate groups, oxirane groups, bismaleimide groups, isocyanate, methylol groups, alkoxymethylalol groups, and ester groups. In certain embodiments, the second component is capable of undergoing a chemical reaction (e.g., with itself and/or with a first component) to form an oligomer, a polymer, a linear polymer, a branched polymer, a copolymer, a crosslinked network, and/or a cured network.

In some embodiments, the second component may be characterized as a component that is part of a cure system. For example, the cure system may be a formulated resin system (e.g., thermoset resin system) including a second component in the form of a monomer (e.g., epoxy). Other components of the cure system may optionally be present in the resin formulations described herein. For example, in some cases, one or more initiators (e.g., triphenyl phosphine, dicyandiamide and 2-methylimidazole for an epoxy cure system) may be present. In certain cases, one or more reactive curatives (e.g., carboxylic acid monomers, carboxylic acid oligomers, carboxylic acid polymers, phenolic monomers, phenolic oligomers, phenolic polymers, amine curative agents, thiol curative agents, diamines, dithiols polyimides, amidoamines, agents that are reactive with epoxy) may be present. In some embodiments, an initiator is required for chemical reactivity of the second component. In other cases, an initiator is not required but may accelerate the reaction rate for a reaction involving the second component.

Non-limiting examples of cure systems include epoxies, terpene phenolics, bismaleimides, cyanate esters, aminoplasts, methylol melamine, isocyanate resins, methylol urea, methylol adducts of organic bases, such as dicyandiamide, guanidine guanylurea, biuret, triuret, etc., and combinations thereof. Accordingly, examples of suitable second components may include mono-, di, tri, etc.-epoxides, poly-epoxides, terpene phenolics, bismaleimides, cyanate esters, methylol melamines, methylol ureas, isocyanate resins, methylol adducts of organic bases such as dicyandiamide, guanidine, guanylurea, biuret, triuret, etc., and combinations thereof. Exemplary optional initiators include dicyandiamide, 2-methylimidazole, mercaptan, hexamethylenetetramine, triphenylphosphine, and combinations thereof.

In some embodiments, the second component may have a certain number average molecular weight. For instance, the second component may have a number average molecular weight of less than or equal to about 3,000 g/mol, less than or equal to about 2,000 g/mol, less than or equal to about 1,000 g/mol, less than or equal to about 500 g/mol, less than or equal to about 250 g/mol, or less than or equal to about 100 g/mol. In some instances, the second component may have a number average molecular weight of greater than or equal to about 20 g/mol, greater than or equal to about 100 g/mol, greater than or equal to about 500 g/mol, greater than or equal to about 1,000 g/mol, or greater than or equal to about 2,000 g/mol. Combinations of the above-referenced ranges are also possible (e.g., greater than or equal to about 20 g/mol and less than or equal to about 3,000 g/mol). Other values of the number average molecular weight of the second component are also possible. The number average molecular weight may be determined as described above. The particular method used may depend on the type of second component being measured.

In some embodiments, the weight percentage of the second component in the resin may be selected as desired. For instance, the weight percentage of the second component in the resin may be greater than or equal to about 1 wt %, greater than or equal to about 10 wt %, greater than or equal to about 25 wt %, greater than or equal to about 40 wt %, greater than or equal to about 55 wt %, greater than or equal to about 70 wt %, or greater than or equal to about 85 wt %. In some instances, the weight percentage of the second component in the resin may be less than or equal to about 100 wt %, less than or equal to about 80 wt %, less than or equal to about 60 wt %, less than or equal to about 45 wt %, less than or equal to about 30 wt %, less than or equal to about 15 wt %, or less than or equal to about 5 wt %. Combinations of the above-referenced ranges are also possible (e.g., greater than or equal to about 1 wt % and less than or equal to about 60 wt %). Other values of weight percentage of the second component in the resin are also possible. The weight percentage of the second component in the resin is based on the percentage of the second component in the dry resin solids and can be determined prior to coating the fiber web.

In some embodiments, in which the resin includes at least one initiator, the resin may have a certain ratio of the initiator to the second component. For instance, the ratio of the initiator to the second component may be greater than or equal to about 0.002:1, greater than or equal to about 0.004:1, greater than or equal to about 0.006:1, greater than or equal to about 0.008:1, greater than or equal to about 0.01:1, greater than or equal to about 0.02:1, or greater than or equal to about 0.03:1. In some instances, the ratio may be less than or equal to about 0.05:1, less than or equal to about 0.03:1, less than or equal to about 0.01:1, less than or equal to about 0.008:1, less than or equal to about 0.006:1, or less than or equal to about 0.004:1. Combinations of the above-referenced ranges are also possible (e.g., greater than or equal to about 0.006:1 and less than or equal to about 0.03:1). Other values of the ratio of the initiator to the second component are also possible. The ratio of the initiator to the second component is based on the moles of second component and initiator in the resin.

In some embodiments, in which the resin includes more than one initiator, the ratio of a first initiator (e.g., dicyandiamide) to a second initiator (e.g., 2-methylimidazole) may be greater than or equal to about 2:1, greater than or equal to about 5:1, greater than or equal to about 8:1, greater than or equal to about 10:1, greater than or equal to about 12:1, greater than or equal to about 14:1, or greater than or equal to about 16:1. In some instances, the ratio of a first initiator to a second initiator may be less than or equal to about 20:1, less than or equal to about 18:1, less than or equal to about 15:1, less than or equal to about 12:1, less than or equal to about 10:1, or less than or equal to about 6:1. Combinations of the above-referenced ranges are also possible (e.g., greater than or equal to about 5:1 and less than or equal to about 15:1). Other values of the ratio of a first initiator to a second initiator are also possible. The ratio of the first initiator to a second initiator is based on the moles of a first initiator and a second initiator in the resin.

As described herein, a fiber web may be coated with a resin that includes at least two components (e.g., a first component and a second component). In some embodiments, the ratio of a first component (e.g., polymer) to a second component (e.g., monomer or oligomer) in the resin may be selected to impart desirable properties (e.g., mechanical properties, chemical reactivity, etc.). For instance, the ratio of a first component to a second component in the resin may be greater than or equal to about 0.01:1, greater than or equal to about 0.1:1, greater than or equal to about 1:1, greater than or equal to about 10:1, greater than or equal to about 20:1, greater than or equal to about 40:1, greater than or equal to about 60:1, or greater than or equal to about 80:1. In some instances, the ratio of a first component to a second component may be less than or equal to about 99:1, less than or equal to about 85:1, less than or equal to about 70:1, less than or equal to about 55:1, less than or equal to about 40:1, less than or equal to about 20:1, or less than or equal to about 5:1. Combinations of the above-referenced ranges are also possible (e.g., greater than or equal to about 1:1 and less than or equal to about 99:1). Other values of ratios of a first component to a second component are also possible. The ratio of a first component to a second component is based on the weight percentage of a first component in the resin to the weight percentage of a second component in the resin.

Any suitable resin may be used to coat a fiber web. In some embodiments, the resin may be solvent based, and may include an aqueous or a non-aqueous solvent (e.g., an organic or inorganic solvent). Non-limiting example of non-aqueous solvents include acetone, methanol, aliphatic alcohols (e.g., ethanol, n-propanol, iso-propanol, n-butyl alcohol, iso-butyl alcohol, branched and unbranched alkyl alcohols, ethylene glycol, diethylene glycol and higher homologs, glycerine, pentaerithritol, diacetone alcohol), aromatic alcohols (e.g., phenol, benzyl alcohol and alkyl-substituted benzyl alcohols, o-cresol, m-cresol, p-cresol, catechol and alkyl-substituted catechols, resorcinol and alkyl-substituted resorcinols), aliphatic ketones (e.g., methyl ethyl ketone, cyclohexanone, diethyl ketone, diisopropyl ketone, methyl iso-butyl ketone, methyl amyl ketone, methyl iso-amyl ketone), esters (e.g., ethyl acetate, methyl acetate, butyl acetate, iso-butyl acetate, amyl acetate, iso-amyl acetate, benzyl acetate, methyl lactate, ethyl lactate, methyl benzoate, dibasic esters such as: mono or di lower alkyl esters of adipic acid, glutaric acid, and succinic acid, ethyl benzoate, iso-propyl benzoate, ethyleneglycol ethylether acetate, ethyleneglycol methylether acetate, diethyleneglycol ethylether acetate, diethyleneglycol methylether acetate, propyleneglycol methylether acetate, propyleneglycol ethylether acetate, ethoxyethyl propionate, phenoxyethyl acetate, tripropyleneglycol diacetate, hexanediol acetate), nitrile solvents (e.g., acetonitrile, propionitrile, butyronitrile), ethers (e.g., dimethyl ether, diethyl ether, di-iso-propyl ether, tetrahydrofuran, dioxanes, diphenyl ether, dimethyoxyethane, glycol ethers and half ethers including ethyleneglycol alkyl ethers, diethyleneglycol dialkyl ethers, diethyleneglycol monoalkyl ethers, propylene glycol dialkyl ethers, propylene glycol monoalkyl ethers, dipropyleneglycol dialkyl ethers, dipropyleneglycol monoalkyl ethers), chlorinated solvents (e.g., chloroform, dichloromethane, dichloroethane, dibromomethane, dibromoethane, carbon tetrachloride, chlorobenxene, p-chloro benzotrifluoride), aliphatic solvents (e.g., pentanes, hexanes, heptanes, octanes, branched aliphatic isomers, higher aliphatic homologs, 2-ethylhexane, 2,2,4-trimethylpentane, naptha, turpentine, terpenoids), ligroine and other mixtures of hydrocarbons typically obtained as a boiling point range fraction during distillation often referred to a petroleum ethers (e.g., mineral spirits, white spirits), terpenes (e.g., monoterpenes, geraniol, limonene, terpineol, sesquiterpenes, humulene, farnesenes, farnesol, diterpenes, cafestol, kahweol, cembrene), aromatic solvents (e.g., benzene, toluene, xylene, mesitylene, ethyl benzene, pyridine and alkyl-substituted pyridines), amide solvents (e.g., formamide, methyl formamide, dimethyl formamide, acetamide, methylacetamide, dimethyl acetamide), lactam solvents (e.g., pyrrolidone, n-methylpyrrolidone, other lower alkyl n-substituted pyrrolidones) sulfoxides (e.g., dimethyl sulfoxide), sulfone solvents (e.g., dimethyl sulfone), acid solvents (e.g., acetic acid, propionic acid), anhydride solvents (e.g., acetic anhydride, propionic anhydride), carbon dioxide, carbon disulfide, fluorinated solvents (e.g., hexafluoroisopropanol, hexafluoroacetone sesquihydrate, 1,1,2,2,3,3,4-heptafluorocyclopentane, 1,1,1,2,2,3,4,5,5,5-decafluoropentane) and combinations thereof.

In some instances, the solvent may include a reactive diluent. For example, a solvent such as one listed above may be combined with a reactive diluent. In other instances, the solvent may be a reactive diluent. In some embodiments, the reactive diluent may react with a component described herein and may form a part of the coating/resin. Exemplary reactive diluents include (cyclo)aliphatic monoepoxides (e.g., 2-ethylhexyl diglycidyl ether, cyclohexane dimethanol diglycidyl ether), monoglycidyl ethers of fatty alcohols (e.g., stearyl alcohol), unsaturated (cyclo)alkyl monoepoxides (e.g., cyclohexenyl glycidyl ether, allyl glycidyl ether, vinyl glycidyl ether, aryl glycidyl ethers), difunctional aliphatic diglycidyl ethers (e.g., 1,4-butanediol diglycidyl ether, 1,6-hexanediol diglycidyl ether, neopentylglycol diglycidyl ether, dipropylene diglycidyl ether, polypropylene diglycidyl ether), acrylates, methacrylates, glycidyl (meth)acrylate, polyoxyamines, (cyclo)aliphatic amines, mannich bases, low molecular weight diols (e.g., ethylene glycol, propylene glycol), low molecular weight triols (e.g., glycerine), diamines (e.g., ethylene diamine, propylene diamine), dithiols, and combinations thereof.

In some embodiments, the weight percentage of solvent in the resin may be greater than or equal to about 30 wt %, greater than or equal to about 40 wt %, greater than or equal to about 50 wt %, greater than or equal to about 60 wt %, greater than or equal to about 70 wt %, greater than or equal to about 80 wt %, or greater than or equal to about 90 wt %. In some instances, the weight percentage of solvent in the resin may be less than or equal to about 99 wt %, less than or equal to about 97 wt %, less than or equal to about 85 wt %, less than or equal to about 75 wt %, less than or equal to about 65 wt %, less than or equal to about 55 wt %, or less than or equal to about 40 wt %. Combinations of the above-referenced ranges are also possible (e.g., greater than or equal to about 60 wt % and less than or equal to about 97 wt %). Other values of weight percentage of solvent in the resin are also possible.

In some embodiments, the viscosity of the resin (e.g., the uncured resin) may be selected as desired. For instance, the resin may have a viscosity of greater than or equal to about 10 cP, greater than or equal to about 30 cP, greater than or equal to about 100 cP, greater than or equal to about 500 cP, greater than or equal to about 1,000 cP, greater than or equal to about 2,000 cP, greater than or equal to about 6,000 cP, greater than or equal to about 10,000 cP, or greater than or equal to about 15,000 cP. In some instances, the viscosity may be less than or equal to about 20,000 cP, less than or equal to about 15,000 cP, less than or equal to about 10,000 cP, less than or equal to about 5,000 cP, less than or equal to about 1,000 cP, less than or equal to about 500 cP, or less than or equal to about 100 cP. Combinations of the above-referenced ranges are also possible (e.g., greater than or equal to about 30 cP and less than or equal to about 1,000 cP, greater than or equal to about 2,000 cP and less than or equal to about 15,000 cP). Other values of the viscosity are also possible. Unless otherwise indicated, the viscosity of the resin is determined according to the standard DIN 53 211.

To form a resin including at least two components, the at least two components may be combined with a predetermined amount of one or more solvents and sufficiently mixed to incorporate each component into the solvent(s). In some instances, incorporating a component into a solvent may involve dissolving the component in the solvent. In other instances, incorporating a component into a solvent may involve forming a suspension of the component in the solvent. A component may also be incorporated into a solvent by forming an emulsion. Other methods of incorporating a component into a solvent are also possible.

Any suitable coating method may be used to form a coating on the fiber web. In some embodiments, the resin may be applied to the fiber web using a non-compressive coating technique. The non-compressive coating technique may coat the fiber web, while not substantially decreasing the thickness of the web. In other embodiments, the resin may be applied to the fiber web using a compressive coating technique. Non-limiting examples of coating methods include the use of a slot die coater, gravure coating, screen coating, size press coating (e.g., a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, laboratory size press coating, melt coating, dip coating, knife roll coating, spin coating, spray coating, gapped roll coating, roll transfer coating, padding saturant coating, and saturation impregnation. Other coating methods are also possible.

In a laboratory size press coating technique, the fiber web is soaked in the resin for a predetermined period of time to allow for resin absorption. The fiber web is then run through a lab coater to squeeze out extra resin in order to obtain a specific amount of resin absorption. The lab coater includes two parallel rolls, one on top of another, with an optional mechanical gap between them. The bottom roll is a driven roll such that when the fiber web is passed through the gap, the top roll turns. When the gap is present, it may be set at a specified thickness for the fiber web.

In a padding saturant coating technique, a specific amount of resin is transferred to a porous pad by dipping the porous pad in the resin or applying the porous pad to a substrate wetted with resin. The porous pad is then applied to a portion of the fiber web using a protocol in which contact time and pressure are controlled. In this manner, the resin is transferred from the porous pad to the fiber web.

In a spray coating technique, the fiber web is sprayed with resin using a nozzle that distributes a stream or mist of resin. The nozzle is manipulated near the fiber web to apply a desired distribution of resin on the fiber web.

In a gravure coating technique, a gravure is used to apply a coating to the fiber web. A gravure is a roll with a cell pattern engraved on the surface. As the roll passes through a trough containing the resin, resin is trapped in the cells and delivered to the fiber web, which wicks the resin out of the gravure roll. The amount of the resin impregnated into the fiber web typically depends on the viscosity, solids content, and absorption rate of the fiber web.

In a curtain coating technique, a curtain of resin is applied to a moving fiber web. The curtain is generally applied by flowing resin from a pool across a weir to a location directly above the moving fiber web, such that the curtain of resin provides a desired rate of resin transfer onto the moving fiber web producing a desired level of resin in the fiber web.

In a roll transfer coating technique, a specific amount of resin is applied to one or more rolls, which transfer the specific amount of resin onto the moving fiber web. Any number of roll configurations involving two or more rolls may be used. When more than two rolls are used, the additional rolls are used to transfer resin from a pan to the applicator rolls or to meter excess resin through a flooded nip to the applicator rolls. The rolls can be smooth and the surfaces can be made of a wide range of materials, including metals, ceramic rubbers, or polymeric materials.

The resin may coat any suitable portion of the fiber web. In some embodiments, the coating of resin may be formed such that the surfaces of the fiber web are coated without substantially coating the interior of the fiber web. In some instances, a single surface of the fiber web may be coated. For example, a top surface or layer of the fiber web may be coated. In other instances, more than one surface or layer of the fiber web may be coated (e.g., the top and bottom surfaces or layers). In other embodiments, at least a portion of the interior of the fiber web may be coated without substantially coating at least one surface or layer of the fiber web. For example, a middle layer of a fiber web may be coated, but one or more layers adjacent to the middle layer may not be coated. The coating may also be formed such that at least one surface or layer of the fiber web and the interior of the fiber web are coated. In some embodiments, the entire web is coated with the resin.

In some embodiments, at least a portion of the fibers of the fiber web may be coated without substantially blocking the pores of the fiber web. In some instances, substantially all of the fibers may be coated without substantially blocking the pores. In some embodiments, the fiber web may be coated with a relatively high weight percentage of resin without blocking the pores of the resin using the methods described herein (e.g., by dissolving and/or suspending one or more components in a solvent to form the resin). Coating the fibers of the web using the resins described herein may add strength and/or flexibility to the fiber web, and leaving the pores substantially unblocked may be important for maintaining or improving certain filtration properties such as air permeability.

In some embodiments, the fiber web may include more than one coating (e.g., on different surfaces of the fiber web). In some cases, the same coating method may be utilized to apply more than one coating. For example, the same coating method may be used to form a first coating on a top surface and a second coating on a bottom surface of the fiber web. In other instances, more than one coating method may be used to apply more than one coating. For example, a first coating method may be used to form a first coating in the interior of the fiber web and a second coating method may be used to form a second coating on a bottom surface of the fiber web. When more than one coating exists on a fiber web, in some embodiments the coatings may have the same resin composition. In other embodiments, the resin compositions may differ with respect to certain properties (e.g., first component, second component, ratio of components).

After applying the resin to the fiber web, the resin may be dried to remove most or substantially all of the solvent by any suitable method. Non-limiting examples of drying methods include the use of a photo dryer, infrared dryer, hot air oven steam-heated cylinder, or any other suitable types of dryers familiar to those of ordinary skill in the art.

After being applied to the fiber web, the resin may undergo at least one chemical reaction to form one or more reaction products as described herein. For example, the components in the resin may be involved in a step-growth polymerization, (e.g., condensation), chain-growth polymerization (e.g., free radical, ionic, etc.), or a crosslinking reaction. The chemical reaction may result in covalent bonding between the components. In some embodiments, external energy (e.g., thermal energy, radiant energy) may be applied to the resin on the fiber web to induce a chemical reaction. In other embodiments, at least one reaction product is formed without the application of external energy.

As described herein, in some embodiments a method of forming a coated fiber web includes applying a pre-polymerized resin to a fiber web. In other embodiments, at least portions of the resin (or components of the resin) may be polymerized prior to applying the resin to the fiber web.

In certain embodiments, at least one reaction product (e.g., a cured network, a copolymer) may be formed by, for example, heating the coated fiber web at a specific temperature for a specific amount of time. For instance, in some embodiments, a coated fiber web may be heated at a temperature of greater than or equal to about 90° C., greater than or equal to about 100° C., greater than or equal to about 120° C., greater than or equal to about 150° C., greater than or equal to about 180° C., greater than or equal to about 210° C., greater than or equal to about 240° C., or greater than or equal to about 270° C. In some instances, the temperature may be less than or equal to about 300° C., less than or equal to about 265° C., less than or equal to about 235° C., less than or equal to about 210° C., less than or equal to about 175° C., less than or equal to about 145° C., or less than or equal to about 115° C. Combinations of the above-referenced ranges are also possible (e.g., greater than or equal to about 100° C. and less than or equal to about 210° C.). Other values of temperature are also possible.

In some embodiments, the time that the coated fiber web is heated may be greater than or equal to about 0.2 min, greater than or equal to about 0.5 min, greater than or equal to about 1 min, greater than or equal to about 5 min, greater than or equal to about 10 min, greater than or equal to about 15 min, or greater than or equal to about 20 min. In some instances, the time may be less than or equal to about 20 min, less than or equal to about 15 min, less than or equal to about 10 min, less than or equal to about 5 min, or less than or equal to about 1 min. Combinations of the above-referenced ranges are also possible (e.g., greater than or equal to about 0.5 min and less than or equal to about 25 min). Other values of time are also possible.

In general, the coating may be any suitable weight percentage of the entire fiber web. For instance, in some embodiments, the weight percentage of the coating in the entire fiber web may be greater than or equal to about 3 wt %, greater than or equal to about 5 wt %, greater than or equal to about 10 wt %, greater than or equal to about 15 wt %, greater than or equal to about 20 wt %, greater than or equal to about 25 wt %, greater than or equal to about 30 wt %, or greater than or equal to about 40 wt %. In some instances, the weight percentage of the coating in the entire fiber web may be less than or equal to about 50 wt %, less than or equal to about 45 wt %, less than or equal to about 35 wt %, less than or equal to about 25 wt %, less than or equal to about 20 wt %, or less than or equal to about 15 wt %. Combinations of the above-referenced ranges are also possible (e.g., greater than or equal to about 5 wt % and less than or equal to about 45 wt %). Other values of weight percentage of the coating in the entire fiber web are also possible. The weight percentage of coating in the entire fiber web is determined after the coating has been dried.

In certain embodiments, the coating may have an average thickness on the fibers of the web. For instance, in some embodiments, the coating may have an average thickness of greater than or equal to about 0.1 microns, greater than or equal to about 1 micron, greater than or equal to about 5 microns, greater than or equal to about 10 microns, greater than or equal to about 20 microns, greater than or equal to about 30 microns, or greater than or equal to about 40 microns. In some instances, the coating may have an average thickness of less than or equal to about 50 microns, less than or equal to about 35 microns, less than or equal to about 25 microns, less than or equal to about 15 microns, less than or equal to about 1 microns, or less than or equal to about 0.5 microns. Combinations of the above-referenced ranges are also possible (e.g., a thickness of greater than or equal to about 1 microns and less than or equal to about 25 microns). Other values of thickness are also possible. The thickness may be determined according to the examination of a cross-section of a fiber or fiber web magnified under scanning-electron microscope or other suitable instrument in which the resin coating is visible around the fiber.

In general, any suitable fiber web may be coated with a resin described herein.

In some embodiments, the fiber web may include one or more glass fibers (e.g., microglass fibers, chopped strand glass fibers, or a combination thereof). Microglass fibers and chopped strand glass fibers are known to those skilled in the art. One skilled in the art is able to determine whether a glass fiber is microglass or chopped strand by observation (e.g., optical microscopy, electron microscopy). Microglass fibers may also have chemical differences from chopped strand glass fibers. In some cases, though not required, chopped strand glass fibers may contain a greater content of calcium or sodium than microglass fibers. For example, chopped strand glass fibers may be close to alkali free with high calcium oxide and alumina content. Microglass fibers may contain 10-15% alkali (e.g., sodium, magnesium oxides) and have relatively lower melting and processing temperatures. The terms refer to the technique(s) used to manufacture the glass fibers. Such techniques impart the glass fibers with certain characteristics. In general, chopped strand glass fibers are drawn from bushing tips and cut into fibers in a process similar to textile production. Chopped strand glass fibers are produced in a more controlled manner than microglass fibers, and as a result, chopped strand glass fibers will generally have less variation in fiber diameter and length than microglass fibers. Microglass fibers are drawn from bushing tips and further subjected to flame blowing or rotary spinning processes. In some cases, fine microglass fibers may be made using a remelting process. In this respect, microglass fibers may be fine or coarse. As used herein, fine microglass fibers are less than or equal to 1 micron in diameter and coarse microglass fibers are greater than or equal to 1 micron in diameter.

The microglass fibers may have small diameters. For instance, in some embodiments, the average diameter of the microglass fibers may be less than or equal to about 9 microns, less than or equal to about 7 microns, less than or equal to about 5 microns, less than or equal to about 3 microns, or less than or equal to about 1 micron. In some instances, the microglass fibers may have an average fiber diameter of greater than or equal to about 0.1 microns, greater than or equal to about 0.3 microns, greater than or equal to about 1 micron, greater than or equal to about 3 microns, or greater than or equal to about 7 microns. Combinations of the above-referenced ranges are also possible (e.g., greater than or equal to about 0.1 microns and less than or equal to about 9 microns). Other values of average fiber diameter are also possible. Average diameter distributions for microglass fibers are generally log-normal. However, it can be appreciated that microglass fibers may be provided in any other appropriate average diameter distribution (e.g., Gaussian distribution).

In some embodiments, the average length of microglass fibers may be less than or equal to about 10 mm, less than or equal to about 8 mm, less than or equal to about 6 mm, less than or equal to about 5 mm, less than or equal to about 4 mm, less than or equal to about 3 mm, or less than or equal to about 2 mm. In certain embodiments, the average length of microglass fibers may be greater than or equal to about 1 mm, greater than or equal to about 2 mm, greater than or equal to about 4 mm, greater than or equal to about 5 mm, greater than equal to about 6 mm, or greater than or equal to about 8 mm. Combinations of the above referenced ranges are also possible (e.g., microglass fibers having an average length of greater than or equal to about 4 mm and less than about 6 mm). Other ranges are also possible.

In other embodiments, the microglass fibers may vary significantly in length as a result of process variations. For instance, in some embodiments, the average aspect ratios (length to diameter ratio) of the microglass fibers in the fiber web may be greater than or equal to about 100, greater than or equal to about 200, greater than or equal to about 300, greater than or equal to about 1000, greater than or equal to about 3,000, greater than or equal to about 6,000, greater than or equal to about 9,000. In some instances, the microglass fibers may have an average aspect ratio of less than or equal to about 10,000, less than or equal to about 5,000, less than or equal to about 2,500, less than or equal to about 600, or less than or equal to about 300. Combinations of the above-referenced ranges are also possible (e.g., greater than or equal to about 200 and less than or equal to about 2,500). Other values of average aspect ratio are also possible. It should be appreciated that the above-noted dimensions are not limiting and that the microglass fibers may also have other dimensions.

In some embodiments, in which microglass fibers are included in the fiber web, the weight percentage of microglass fibers in the fiber web may be greater than or equal to about 1 wt %, greater than or equal to about 10 wt %, greater than or equal to about 30 wt %, greater than or equal to about 50 wt %, greater than or equal to about 70 wt %, or greater than or equal to about 90 wt %. In some instances, the weight percentage of microglass fibers in the fiber web may be less than or equal to about 100 wt %, less than or equal to about 95 wt %, less than or equal to about 80 wt %, less than or equal to about 60 wt %, less than or equal to about 40 wt %, less than or equal to about 20 wt %, or less than or equal to about 10 wt %. Combinations of the above-referenced ranges are also possible (e.g., greater than or equal to about 1 wt % and less than or equal to about 95 wt %). Other values of weight percentage of the microglass fibers in the fiber web are also possible. In other embodiments, the fiber web contains 0 wt % microglass fibers.

In general, chopped strand glass fibers may have an average fiber diameter that is greater than the diameter of the microglass fibers. For instance, in some embodiments, the average diameter of the chopped strand glass fibers may be greater than or equal to about 5 microns, greater than or equal to about 7 microns, greater than or equal to about 9 microns, greater than or equal to about 11 microns, or greater than or equal to about 20 microns. In some instances, the chopped strand glass fibers may have an average fiber diameter of less than or equal to about 30 microns, less than or equal to about 25 microns, less than or equal to about 15 microns, less than or equal to about 12 microns, or less than or equal to about 10 microns. Combinations of the above-referenced ranges are also possible (e.g., greater than or equal to about 5 microns and less than or equal to about 12 microns). Other values of average fiber diameter are also possible. Chopped strand diameters tend to follow a normal distribution. Though, it can be appreciated that chopped strand glass fibers may be provided in any appropriate average diameter distribution (e.g., Gaussian distribution).

In some embodiments, chopped strand glass fibers may have a length in the range of between about 0.125 inches and about 1 inch (e.g., about 0.25 inches, or about 0.5 inches). In some embodiments, the average length of chopped strand glass fibers may be less than or equal to about 1 inch, less than or equal to about 0.8 inches, less than or equal to about 0.6 inches, less than or equal to about 0.5 inches, less than or equal to about 0.4 inches, less than or equal to about 0.3 inches, or less than or equal to about 0.2 inches. In certain embodiments, the average length of chopped strand glass fibers may be greater than or equal to about 0.125 inches, greater than or equal to about 0.2 inches, greater than or equal to about 0.4 inches, greater than or equal to about 0.5 inches, greater than equal to about 0.6 inches, or greater than or equal to about 0.8 inches. Combinations of the above referenced ranges are also possible (e.g., chopped strand glass fibers having an average length of greater than or equal to about 0.125 inches and less than about 1 inch). Other ranges are also possible.

It should be appreciated that the above-noted dimensions are not limiting and that the microglass and/or chopped strand fibers, as well as the other fibers described herein, may also have other dimensions.

In some embodiments, in which chopped strand glass fibers are included in the fiber web, the weight percentage of chopped strand glass fibers in the fiber web may be greater than or equal to about 1 wt %, greater than or equal to about 10 wt %, greater than or equal to about 20 wt %, greater than or equal to about 30 wt %, greater than or equal to about 40 wt %, or greater than or equal to about 55 wt %. In some instances, the weight percentage of chopped strand glass fibers in the fiber web may be less than or equal to about 70 wt %, less than or equal to about 60 wt %, less than or equal to about 40 wt %, less than or equal to about 30 wt %, less than or equal to about 20 wt %, or less than or equal to about 10 wt %. Combinations of the above-referenced ranges are also possible (e.g., greater than or equal to about 1 wt % and less than or equal to about 60 wt %). Other values of weight percentage of the chopped strand glass fibers in the fiber web are also possible. In other embodiments, the fiber web contains 0 wt % chopped glass fibers.

In some embodiments, in which more than one type of glass fibers are included in the fiber web, the total weight percentage of glass fibers (e.g., microglass fibers, chopped strand glass fibers, or a combination thereof) in the fiber web may be greater than or equal to about 1 wt %, greater than or equal to about 10 wt %, greater than or equal to about 30 wt %, greater than or equal to about 50 wt %, greater than or equal to about 70 wt %, or greater than or equal to about 90 wt %. In some instances, the total weight percentage of glass fibers in the fiber web may be less than or equal to about 100 wt %, less than or equal to about 95 wt %, less than or equal to about 80 wt %, less than or equal to about 60 wt %, less than or equal to about 40 wt %, less than or equal to about 20 wt %, or less than or equal to about 10 wt %. Combinations of the above-referenced ranges are also possible (e.g., greater than or equal to about 10 wt % and less than or equal to about 95 wt %). Other values of total weight percentage of the glass fibers in the fiber web are also possible. In some embodiments, the fiber web contains 100 wt % glass fibers. In other embodiments, the fiber web contains 0 wt % glass fibers.

In some embodiments, the fibers in the fiber web may include synthetic fibers. Synthetic fibers may include any suitable type of synthetic polymer. Examples of suitable synthetic fibers include polyester, polycarbonate, polyamide, polyaramid, polyimide, polyethylene, polypropylene, polyether ether ketone, polyethylene terephthalate, polyolefin, nylon, acrylics, polyvinyl alcohol, regenerated cellulose (e.g., lyocell, rayon), and combinations thereof. In some embodiments, the synthetic fibers are organic polymer fibers. In some cases, synthetic fibers may include meltblown fibers, which may be formed of polymers. In other cases, synthetic fibers may be electrospun fibers. The fiber web may also include combinations of more than one type of synthetic fiber. In yet other cases, synthetic fibers may be staple fibers.

In some embodiments, the average diameter of the synthetic fibers in the fiber web may be, for example, greater than or equal to about 0.1 microns, greater than or equal to about 0.3 microns, greater than or equal to about 0.5 microns, greater than or equal to about 1 micron, greater than or equal to about 2 microns, greater than or equal to about 3 microns, greater than or equal to about 4 microns, greater than or equal to about 5 microns, greater than or equal to about 8 microns, greater than or equal to about 10 microns, greater than or equal to about 12 microns, greater than or equal to about 15 microns, or greater than or equal to about 20 microns. In some instances, the synthetic fibers may have an average diameter of less than or equal to about 30 microns, less than or equal to about 20 microns, less than or equal to about 15 microns, less than or equal to about 10 microns, less than or equal to about 7 microns, less than or equal to about 5 microns, less than or equal to about 4 microns, less than or equal to about 1.5 microns, less than or equal to about 1 micron, less than or equal to about 0.8 microns, or less than or equal to about 0.5 microns. Combinations of the above-referenced ranges are also possible (e.g., greater than or equal to about 1 micron and less than or equal to about 5 microns). Other values of average fiber diameter are also possible.

In some cases, the synthetic fibers may be continuous (e.g., meltblown fibers, spunbond fibers, electrospun fibers, centrifugal spun fibers, etc.). For instance, synthetic fibers may have an average length of greater than or equal to about 1 inch, greater than or equal to about 50 inches, greater than or equal to about 100 inches, greater than or equal to about 300 inches, greater than or equal to about 500 inches, greater than or equal to about 700 inches, or greater than or equal to about 900 inches. In some instances, synthetic fibers may have an average length of less than or equal to about 1000 inches, less than or equal to about 800 inches, less than or equal to about 600 inches, less than or equal to about 400 inches, or less than or equal to about 100 inches. Combinations of the above-referenced ranges are also possible (e.g., greater than or equal to about 50 inches and less than or equal to about 1000 inches). Other values of average fiber length are also possible.

In some embodiments, the synthetic fibers are not continuous (e.g., staple fibers). For instance, in some embodiments, the synthetic fibers in the fiber web may have an average length of greater than or equal to about 2 mm, greater than or equal to about 4 mm, greater than or equal to about 6 mm, greater than or equal to about 8 mm, greater than or equal to about 10 mm, greater than or equal to about 15 mm, or greater than or equal to about 20 mm. In some instances, the synthetic fibers may have an average length of less than or equal to about 25 mm, less than or equal to about 20 mm, less than or equal to about 15 mm, less than or equal to about 12 mm, less than or equal to about 10 mm, less than or equal to about 8 mm, or less than or equal to about 5 mm. Combinations of the above-referenced ranges are also possible (e.g., greater than or equal to about 4 mm and less than or equal to about 20 mm). Other values of average fiber length are also possible. In other embodiments, the synthetic fibers may be continuous.

In some embodiments, in which synthetic fibers are included in the fiber web, the weight percentage of synthetic fibers in the fiber web may be greater than or equal to about 1 wt %, greater than or equal to about 5 wt %, greater than or equal to about 25 wt %, greater than or equal to about 40 wt %, greater than or equal to about 55 wt %, greater than or equal to about 70 wt %, or greater than or equal to about 85 wt %. In some instances, the weight percentage of the synthetic fibers in the fiber web may be less than or equal to about 100 wt %, less than or equal to about 80 wt %, less than or equal to about 60 wt %, less than or equal to about 40 wt %, less than or equal to about 20 wt %, or less than or equal to about 5 wt %. Combinations of the above-referenced ranges are also possible (e.g., greater than or equal to about 1 wt % and less than or equal to about 100 wt %). Other values of weight percentage of synthetic fibers in the fiber web are also possible. In some embodiments, the fiber web may include 100 wt % synthetic fibers. In other embodiments, the fiber web may include 0 wt % synthetic fibers.

In some embodiments, the fiber web may include one or more cellulose fibers, such as softwood fibers, hardwood fibers, a mixture of hardwood and softwood fibers, regenerated cellulose fibers, and mechanical pulp fibers (e.g., groundwood, chemically treated mechanical pulps, and thermomechanical pulps). Exemplary softwood fibers include fibers obtained from mercerized southern pine (e.g., mercerized southern pine fibers or “HPZ fibers”, “HPZ XS fibers,” and “HPZ III fibers” or “Porosanier fibers”), northern bleached softwood kraft (e.g., fibers obtained from Rottneros AB (“Robur Flash fibers”)), southern bleached softwood kraft (e.g., fibers obtained from Brunswick pine (“Brunswick pine fibers”)), or chemically treated mechanical pulps (“CTMP fibers”). For example, HPZ fibers, HPZ XS, and HPZ III can be obtained from Buckeye Technologies, Inc., Memphis, Tenn.; Porosanier fibers can be obtained from Rayonier, Inc., Jacksonville, Fla.; Robur Flash fibers can be obtained from Rottneros AB, Stockholm, Sweden; Chinook fibers can be obtained from Domtar Corp., Montreal, QC; Brunswick pine and Leaf River fibers can be obtained from Georgia-Pacific, Atlanta, Ga.; and Tarascon fibers can be obtained from Paper Excellence, Vancouver, BC, Canada (“Tarascon fibers”). Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), and (2) Group Portucel Soporcel, Cacia, Portugal (“Cacia fibers”). Other exemplary hardwood fibers may be obtained from New Page Corp., Miamisburg, Ohio (“Pinnacle Prime fibers”).

In some embodiments, in which the fiber web includes cellulose fibers, the average diameter of the cellulose fibers in the fiber web may be, for example, greater than or equal to about 1 micron, greater than or equal to about 5 microns, greater than or equal to about 10 microns, greater than or equal to about 20 microns, greater than or equal to about 30 microns, greater than or equal to about 40 microns, greater than or equal to about 50 microns, or greater than or equal to about 60 microns. In some instances, the cellulose fibers may have an average diameter of less than or equal to about 75 microns, less than or equal to about 65 microns, less than or equal to about 55 microns, less than or equal to about 45 microns, less than or equal to about 35 microns, less than or equal to about 25 microns, less than or equal to about 15 microns, or less than or equal to about 5 microns. Combinations of the above-referenced ranges are also possible (e.g., greater than or equal to about 1 micron and less than or equal to about 5 microns). Other values of average fiber diameter are also possible.

In some embodiments, the cellulose fibers may have an average length. For instance, in some embodiments, cellulose fibers may have an average length of greater than or equal to about 0.5 mm, greater than or equal to about 1 mm, greater than or equal to about 3 mm, greater than or equal to about 6 mm, greater than or equal to about 8 mm, greater than or equal to about 10 mm, greater than or equal to about 15 mm, or greater than or equal to about 20 mm. In some instances, cellulose fibers may have an average length of less than or equal to about 25 mm, less than or equal to about 20 mm, less than or equal to about 15 mm, less than or equal to about 12, less than or equal to about 10 mm, less than or equal to about 4 mm, or less than or equal to about 1 mm. Combinations of the above-referenced ranges are also possible (e.g., greater than or equal to about 1 mm and less than or equal to about 4 mm). Other values of average fiber length are also possible.

In some embodiments, the fiber web may include a certain weight percentage of cellulose fibers. For example, the weight percentage of cellulose fibers in the fiber web may be greater than or equal to about 1 wt %, greater than or equal to about 10 wt %, greater than or equal to about 30 wt %, greater than or equal to about 50 wt %, greater than or equal to about 70 wt %, or greater than or equal to about 90 wt %. In some instances, the weight percentage of cellulose fibers in the fiber web may be less than or equal to about 100 wt %, less than or equal to about 90 wt %, less than or equal to about 80 wt %, less than or equal to about 60 wt %, less than or equal to about 40 wt %, less than or equal to about 20 wt %, or less than or equal to about 5 wt %. Combinations of the above-referenced ranges are also possible (e.g., greater than or equal to about 1 wt % and less than or equal to about 20 wt %). In certain embodiments, the fiber web may include 0 wt % cellulose fibers. Other values of weight percentage of cellulose fibers in the fiber web are also possible.

Although various ranges of synthetic and cellulose fibers are described, in certain preferred embodiments, the fiber web includes predominately glass fibers.

In some embodiments, the fiber web does not include any fibrillated fibers (e.g., 0 wt %), or includes minimal amounts of fibrillated fibers. As known to those of ordinary skill in the art, a fibrillated fiber includes a parent fiber that branches into smaller diameter fibrils, which can, in some instances, branch further out into even smaller diameter fibrils with further branching also being possible. In certain embodiments, the fiber web may include a relatively small weight percentage of fibrillated fibers (e.g., less than or equal to about 5 wt %, less than or equal to about 3 wt %, less than or equal to about 2 wt %, less than 1 wt %, less than 0.8 wt %, or less than 0.5 wt % fibrillated fibers (e.g., 0-5 wt %, 0-3 wt %, 0-2 wt %, 0-1 wt %, 0-0.8 wt %, or 0-0.5 wt % fibrillated fibers)). In embodiments in which fibrillated fibers are present, the fiber composition, diameter, and length may be selected as desired. In general, the fibrillated fibers may have any suitable composition.

In some embodiments, the fiber web does not include any thermoplastic binder fibers (e.g., bicomponent fibers), or includes minimal amounts of thermoplastic binder fibers. For example, a fiber web including a relatively small weight percentage of thermoplastic binder fibers may have, for example, less than or equal to about 5 wt %, less than or equal to about 3 wt %, less than or equal to about 2 wt %, less than 1 wt %, less than 0.8 wt %, or less than 0.5 wt % thermoplastic binder fibers (e.g., 0-5 wt %, 0-3 wt %, 0-2 wt %, 0-1 wt %, 0-0.8 wt %, 0-0.5 wt % thermoplastic binder fibers). In embodiments in which thermoplastic binder fibers are present, the fiber composition, diameter, and length may be selected as desired. In general, the thermoplastic binder fibers comprise any suitable thermoplastic polymer.

In certain embodiments, the fiber web may include a single phase. In other embodiments, however, a fiber web may include more than one phase (e.g., two or more phases). When a fiber web includes more than one phase, the plurality of phases may differ based on certain features such as fiber type (e.g., glass, synthetic, meltblown, staple), fiber size (e.g., length, diameter), weight percentage of each fiber type, structural properties (e.g., basis weight), filtration properties (e.g., efficiency, dust holding capacity, air permeability), etc. In one embodiment, the fiber web may include at least two phases (e.g., a first phase and a second phase). In some instances, the first and second phases may differ in the weight percentage of each fiber type, and in some instances the weight percentage of each fiber type may be substantially the same. For example, the first phase and second phase may include fibers (e.g., microglass, chopped strand, synthetic), as described herein.

In some embodiments, the weight percentage of microglass fibers in the first phase may be greater than or equal to about 1 wt %, greater than or equal to about 10 wt %, greater than or equal to about 30 wt %, greater than or equal to about 50 wt %, greater than or equal to about 70 wt %, or greater than or equal to about 90 wt %. In some instances, the weight percentage of microglass fibers in the first phase may be less than or equal to about 100 wt %, less than or equal to about 95 wt %, less than or equal to about 80 wt %, less than or equal to about 60 wt %, less than or equal to about 40 wt %, less than or equal to about 20 wt %, or less than or equal to about 10 wt %. Combinations of the above-referenced ranges are also possible (e.g., greater than or equal to about 1 wt % and less than or equal to about 95 wt %). Other values of weight percentage of the microglass fibers in the first phase are also possible. In some embodiments, the first phase contains 100 wt % microglass fibers. In other embodiments, the first phase contains 0 wt % microglass fibers.

In some embodiments, the weight percentage of chopped strand glass fibers in the first phase may be greater than or equal to about 0 wt %, greater than or equal to about 10 wt %, greater than or equal to about 20 wt %, greater than or equal to about 30 wt %, greater than or equal to about 40 wt %, or greater than or equal to about 55 wt %. In some instances, the weight percentage of chopped strand glass fibers in the first phase may be less than or equal to about 70 wt %, less than or equal to about 60 wt %, less than or equal to about 50 wt %, less than or equal to about 40 wt %, less than or equal to about 30 wt %, less than or equal to about 20 wt %, or less than or equal to about 10 wt %. Combinations of the above-referenced ranges are also possible (e.g., greater than or equal to about 1 wt % and less than or equal to about 60 wt %). Other values of weight percentage of the chopped strand glass fibers in the first phase are also possible. In other embodiments, the first phase contains 0 wt % chopped strand glass fibers.

In some embodiments, in which more than one type of glass fibers are included in the fiber web, the total weight percentage of glass fibers (e.g., microglass fibers, chopped strand glass fibers, or a combination thereof) in the first phase may be greater than or equal to about 1 wt %, greater than or equal to about 10 wt %, greater than or equal to about 30 wt %, greater than or equal to about 50 wt %, greater than or equal to about 70 wt %, or greater than or equal to about 90 wt %. In some instances, the total weight percentage of glass fibers in the first phase may be less than or equal to about 100 wt %, less than or equal to about 95 wt %, less than or equal to about 80 wt %, less than or equal to about 60 wt %, less than or equal to about 40 wt %, less than or equal to about 20 wt %, or less than or equal to about 10 wt %. Combinations of the above-referenced ranges are also possible (e.g., greater than or equal to about 10 wt % and less than or equal to about 95 wt %). Other values of total weight percentage of the glass fibers in the first phase are also possible. In some embodiments, the first phase contains 100 wt % glass fibers. In other embodiments, the first phase contains 0 wt % glass fibers.

In some embodiments, in which synthetic fibers are included in the first phase, the weight percentage of synthetic fibers in the first phase may be greater than or equal to about 1 wt %, greater than or equal to about 5 wt %, greater than or equal to about 25 wt %, greater than or equal to about 40 wt %, greater than or equal to about 55 wt %, greater than or equal to about 70 wt %, or greater than or equal to about 85 wt %. In some instances, the weight percentage of the synthetic fibers in the first phase may be less than or equal to about 100 wt %, less than or equal to about 80 wt %, less than or equal to about 60 wt %, less than or equal to about 40 wt %, less than or equal to about 20 wt %, or less than or equal to about 5 wt %. Combinations of the above-referenced ranges are also possible (e.g., greater than or equal to about 1 wt % and less than or equal to about 100 wt %). Other values of weight percentage of synthetic fibers in the first phase are also possible. In certain embodiments, the first phase may include 100 wt % synthetic fibers. In other embodiments, the first phase may include 0 wt % synthetic fibers.

In some embodiments, the weight percentage of microglass fibers in the second phase may be greater than or equal to about 1 wt %, greater than or equal to about 10 wt %, greater than or equal to about 30 wt %, greater than or equal to about 50 wt %, greater than or equal to about 70 wt %, or greater than or equal to about 90 wt %. In some instances, the weight percentage of microglass fibers in the second phase may be less than or equal to about 100 wt %, less than or equal to about 95 wt %, less than or equal to about 80 wt %, less than or equal to about 60 wt %, less than or equal to about 40 wt %, less than or equal to about 20 wt %, or less than or equal to about 10 wt %. Combinations of the above-referenced ranges are also possible (e.g., greater than or equal to about 1 wt % and less than or equal to about 95 wt %). Other values of weight percentage of the microglass fibers in the second phase are also possible. In some embodiments, the second phase contains 100 wt % microglass fibers. In other embodiments, the second phase contains 0 wt % microglass fibers.

In some embodiments, the weight percentage of chopped strand glass fibers in the second phase may be greater than or equal to about 0 wt %, greater than or equal to about 10 wt %, greater than or equal to about 20 wt %, greater than or equal to about 30 wt %, greater than or equal to about 40 wt %, or greater than or equal to about 55 wt %. In some instances, the weight percentage of chopped strand glass fibers in the second phase may be less than or equal to about 70 wt %, less than or equal to about 60 wt %, less than or equal to about 50 wt %, less than or equal to about 40 wt %, less than or equal to about 30 wt %, less than or equal to about 20 wt %, or less than or equal to about 10 wt %. Combinations of the above-referenced ranges are also possible (e.g., greater than or equal to about 1 wt % and less than or equal to about 60 wt %). Other values of weight percentage of the chopped strand glass fibers in the second phase are also possible. In some embodiments, the second phase contains 0 wt % chopped strand glass fibers.

In some embodiments, in which more than one type of glass fibers are included in the fiber web, the total weight percentage of glass fibers (e.g., microglass fibers, chopped strand glass fibers, or a combination thereof) in the second phase may be greater than or equal to about 1 wt %, greater than or equal to about 10 wt %, greater than or equal to about 30 wt %, greater than or equal to about 50 wt %, greater than or equal to about 70 wt %, or greater than or equal to about 90 wt %. In some instances, the total weight percentage of glass fibers in the second phase may be less than or equal to about 100 wt %, less than or equal to about 95 wt %, less than or equal to about 80 wt %, less than or equal to about 60 wt %, less than or equal to about 40 wt %, less than or equal to about 20 wt %, or less than or equal to about 10 wt %. Combinations of the above-referenced ranges are also possible (e.g., greater than or equal to about 10 wt % and less than or equal to about 95 wt %). Other values of total weight percentage of the glass fibers in the second phase are also possible. In some embodiments, the second phase contains 100 wt % glass fibers. In other embodiments, the second phase contains 0 wt % glass fibers.

In some embodiments, in which synthetic fibers are included in the second phase, the weight percentage of synthetic fibers in the second phase may be greater than or equal to about 1 wt %, greater than or equal to about 5 wt %, greater than or equal to about 25 wt %, greater than or equal to about 40 wt %, greater than or equal to about 55 wt %, greater than or equal to about 70 wt %, or greater than or equal to about 85 wt %. In some instances, the weight percentage of the synthetic fibers in the second phase may be less than or equal to about 100 wt %, less than or equal to about 80 wt %, less than or equal to about 60 wt %, less than or equal to about 40 wt %, less than or equal to about 20 wt %, or less than or equal to about 5 wt %. Combinations of the above-referenced ranges are also possible (e.g., greater than or equal to about 1 wt % and less than or equal to about 100 wt %). Other values of weight percentage of synthetic fibers in the second phase are also possible. In certain embodiments, the second phase may include 100 wt % synthetic fibers. In other embodiments, the second phase may include 0 wt % synthetic fibers.

In some instances, the basis weight of the first phase and the second phase may differ. In other instances, the basis weight of the first and second phase may be substantially the same. For instance, in some embodiments, the basis weight of the first phase may be greater than or equal to about 1 g/m², greater than or equal to about 15 g/m², greater than or equal to about 30 g/m², greater than or equal to about 45 g/m², greater than or equal to about 60 g/m², greater than or equal to about 75 g/m², or greater than or equal to about 90 g/m². In some instances, the first phase may have a basis weight of less than or equal to about 150 g/m², less than or equal to about 125 g/m², less than or equal to about 100 g/m², less than or equal to about 75 g/m², less than or equal to about 50 g/m², less than or equal to about 40 g/m², less than or equal to about 25 g/m², or less than or equal to about 10 g/m². Combinations of the above-referenced ranges are also possible (e.g., greater than or equal to about 15 g/m² and less than or equal to about 100 g/m²). Other values of basis weight are also possible. The basis weight may be determined according to the standard TAPPI T410.

In some embodiments, the basis weight of the second phase may be greater than or equal to about 10 g/m², greater than or equal to about 25 g/m², greater than or equal to about 50 g/m², greater than or equal to about 80 g/m², greater than or equal to about 110 g/m², greater than or equal to about 150 g/m², greater than or equal to about 200 g/m², greater than or equal to about 250 g/m², greater than or equal to about 350 g/m², or greater than or equal to about 350 g/m². In some instances, the second phase may have a basis weight of less than or equal to about 400 g/m², less than or equal to about 350 g/m², less than or equal to about 300 g/m², less than or equal to about 250 g/m², less than or equal to about 200 g/m², less than or equal to about 160 g/m², less than or equal to about 120 g/m², less than or equal to about 70 g/m², or less than or equal to about 30 g/m². Combinations of the above-referenced ranges are also possible (e.g., greater than or equal to about 25 g/m² and less than or equal to about 300 g/m²). Other values of basis weight are also possible. The basis weight may be determined according to the standard TAPPI T410.

A fiber web may also include additional phases (e.g., a third phase, a fourth phase), each of the additional phases having one or more characteristics of a “first phase” or a “second phase” described herein.

As described in more detail below, in some embodiments a fiber web includes at least first and second layers that are stacked or otherwise joined together (e.g., by lamination). In some embodiments, the first and second layers may have the characteristics described above for the first and second phases, respectively.

The fiber web that is coated with a resin, as described herein, may have certain structural characteristics, such as basis weight and thickness. For instance, in some embodiments, the coated fiber web may have a basis weight of greater than or equal to about 10 g/m², greater than or equal to about 25 g/m², greater than or equal to about 50 g/m², greater than or equal to about 80 g/m², greater than or equal to about 110 g/m², greater than or equal to about 150 g/m², greater than or equal to about 200 g/m², greater than or equal to about 250 g/m², greater than or equal to about 300 g/m², or greater than or equal to about 350 g/m². In some instances, the coated fiber web may have a basis weight of less than or equal to about 400 g/m², less than or equal to about 350 g/m², less than or equal to about 300 g/m², less than or equal to about 250 g/m², less than or equal to about 200 g/m², less than or equal to about 160 g/m², less than or equal to about 120 g/m², less than or equal to about 70 g/m², or less than or equal to about 30 g/m². Combinations of the above-referenced ranges are also possible (e.g., greater than or equal to about 25 g/m² and less than or equal to about 300 g/m²). Other values of basis weight are also possible. The basis weight may be determined according to the standard TAPPI T410. In some embodiments, a single, coated layer of the fiber web has a basis weight within one or more the ranges described above. In some instances, the fiber web may include more than one such coated layers.

The thickness of the coated fiber web may be selected as desired. For instance, in some embodiments, the coated fiber web may have a thickness of greater than or equal to about 0.1 mm, greater than or equal to about 0.2 mm, greater than or equal to about 0.4 mm, greater than or equal to about 0.5 mm, greater than or equal to about 0.8 mm, greater than or equal to about 1.0 mm, greater than or equal to about 1.5 mm, or greater than or equal to about 2.0 mm. In some instances, the coated fiber web may have a thickness of less than or equal to about 2.5 mm, less than or equal to about 2.0, less than or equal to about 1.7 mm, less than or equal to about 1.3 mm, less than or equal to about 1.0 mm, less than or equal to about 0.7 mm, or less than or equal to about 0.4 mm. Combinations of the above-referenced ranges are also possible (e.g., a thickness of greater than or equal to about 0.2 mm and less than or equal to about 2.0 mm). Other values of thickness are also possible. The thickness may be determined according to the standard TAPPI 411. In some embodiments, a single, coated layer of the fiber web has a thickness within one or more the ranges described above. In some instances, the fiber web may include more than one such coated layers.

A fiber web that is coated with a resin, as described herein, may have certain enhanced mechanical properties, such as tensile strength, Mullen Burst strength, and elongation. In some embodiments, the enhanced mechanical properties of the coated fiber web may eliminate the need for additional support structures (e.g., scrim) in filter media and/or elements formed of the webs. In certain embodiments, the enhanced mechanical properties of the coated fiber web (including the ranges of tensile strength, Mullen Burst strength, and/or elongation described below) may be achieved for a fiber web that includes relatively low amounts of fibrillated fibers and/or thermoplastic binder fibers, as described herein (e.g., less than or equal to about 5 wt %, less than or equal to about 3 wt %, less than or equal to about 2 wt %, or less than 1 wt %).

In some embodiments, the coated fiber web may have a dry tensile strength in the machine direction (MD) of greater than or equal to about 2 lb/in, greater than or equal to about 5 lb/in, greater than or equal to about 10 lb/in, greater than or equal to about 25 lb/in, greater than or equal to about 50 lb/in, greater than or equal to about 75 lb/in, greater than or equal to about 100 lb/in, or greater than or equal to about 125 lb/in. In some instances, the dry tensile strength in the machine direction may be less than or equal to about 150 lb/in, less than or equal to about 125 lb/in, less than or equal to about 100 lb/in, less than or equal to about 75 lb/in, less than or equal to about 60 lb/in, less than or equal to about 45 lb/in, less than or equal to about 30 lb/in, or less than or equal to about 15 lb/in. Combinations of the above-referenced ranges are also possible (e.g., greater than or equal to about 5 lb/in and less than or equal to about 100 lb/in). Other values of dry tensile strength in the machine direction are also possible. The dry tensile strength in the machine direction may be determined according to the standard T494 om-96 using a jaw separation speed of 1 in/min.

In some embodiments, the coated fiber web may have a dry Mullen Burst strength of greater than or equal to about 10 psi, greater than or equal to about 25 psi, greater than or equal to about 50 psi, greater than or equal to about 75 psi, greater than or equal to about 100 psi, greater than or equal to about 125 psi, greater than or equal to about 150 psi, or greater than or equal to about 200 psi. In some instances, the dry Mullen Burst strength may be less than or equal to about 250 psi, less than or equal to about 225 psi, less than or equal to about 200 psi, less than or equal to about 175 psi, less than or equal to about 150 psi, less than or equal to about 125 psi, less than or equal to about 100 psi, less than or equal to about 75 psi, less than or equal to about 50 psi, or less than or equal to about 25 psi. Combinations of the above-referenced ranges are also possible (e.g., greater than or equal to about 10 psi and less than or equal to about 200 psi). Other values of dry Mullen Burst strength are also possible. The dry Mullen Burst strength may be determined according to the standard T403 om-91.

In some embodiments, the coated fiber web may have a dry tensile elongation at break in the machine direction of greater than or equal to about 2%, greater than or equal to about 3%, greater than or equal to about 10%, greater than or equal to about 15%, greater than or equal to about 25%, greater than or equal to about 35%, or greater than or equal to about 45%. In some instances, the dry tensile elongation at break in the machine direction may be less than or equal to about 50%, less than or equal to about 40%, less than or equal to about 30%, less than or equal to about 20%, less than or equal to about 15%, less than or equal to about 10%, or less than or equal to about 5%. Combinations of the above-referenced ranges are also possible (e.g., greater than or equal to about 3% and less than or equal to about 40%). Other values of dry tensile elongation at break in the machine direction are also possible. The dry tensile elongation at break in the machine direction may be determined according to the standard T494 om-96 using a test span of 4 in and a jaw separation speed of 1 in/min.

It should be appreciated that in some embodiments, a single, coated layer of the fiber web has a tensile strength, a Mullen Burst strength, and/or an elongation within one or more the ranges described above. In some instances, the fiber web may include more than one such coated layers (e.g., two, three, four, etc. layers).

A fiber web described herein may also exhibit advantageous filtration performance characteristics, such as air permeability, dust holding capacity (DHC), efficiency, and mean flow pore size. In certain embodiments, the fiber web may be coated without substantially blocking the pores of the fiber web and negatively affecting air permeability. For instance, in some embodiments, a coated fiber web may have an air permeability of greater than or equal to about 1 CFM, greater than or equal to about 2 CFM, greater than or equal to about 5 CFM, greater than or equal to about 15 CFM, greater than or equal to about 30 CFM, greater than or equal to about 45 CFM, greater than or equal to about 60 CFM, greater than or equal to about 75 CFM, greater than or equal to about 90 CFM, or greater than or equal to about 80 CFM. In some instances, the coated fiber web may have an air permeability of less than or equal to about 150 CFM, less than or equal to about 135 CFM, less than or equal to about 120 CFM, less than or equal to about 100 CFM, less than or equal to about 80 CFM, less than or equal to about 60 CFM, less than or equal to about 40 CFM, less than or equal to about 20 CFM, less than or equal to about 15 CFM, or less than or equal to about 5 CFM. Combinations of the above-referenced ranges are also possible (e.g., greater than or equal to about 2 CFM and less than or equal to about 120 CFM). Other values of air permeability are also possible. The air permeability may be determined according to the standard TAPPI T-215 using a test area of 38 cm² and a pressure drop of 125 Pa (0.5 inches of water).

The dust holding capacity may be measured according to the Palas test or the Multipass test. The dust holding capacity may be tested based on Palas filtration performance (i.e., the Palas test) according to ISO Procedure 5011:2000, “Inlet air cleaning equipment for internal combustion engines and compressors—performance testing”. Such testing is based on the following parameters: test filter area of the fiber web is 100 cm²; face velocity is 20 cm/sec; dust mass concentration is 200 mg/m³; dust/aerosol is SAE fine; total volume flow is about 120.0 L/min, and no discharge. The dust holding capacity is the difference in the weight of the fiber web before the exposure to the fine dust and the weight of the fiber web after the exposure to the fine dust when the pressure drop across the fiber web reaches 1,500 Pa, divided by the area of the fiber web. Dust holding capacity may be determined according to the weight (g) of dust captured per square meter of the media (e.g., through a 100 cm² test area).

The dust holding capacity may also be tested based on a Multipass Filter Test following the ISO 16889 procedure (i.e., a Multipass test) on a Multipass Filter Test Stand manufactured by FTI (e.g., Model No. TE9635). The testing uses ISO 12103-A3 medium grade test dust at a base upstream gravimetric dust level (BUGL) of 10 mg/liter. The test fluid is Aviation Hydraulic Fluid AERO HFA MIL H-5606A manufactured by Mobil. The test is run at a face velocity of 0.06 cm/s until a terminal pressure of 172 kPa.

In some embodiments, the coated fiber web may have a DHC of greater than or equal to about 50 g/m², greater than or equal to about 70 g/m², greater than or equal to about 100 g/m², greater than or equal to about 125 g/m², greater than or equal to about 150 g/m², greater than or equal to about 175 g/m², greater than or equal to about 200 g/m², greater than or equal to about 225 g/m², greater than or equal to about 250 g/m², greater than or equal to about 275 g/m², or greater than or equal to about 300 g/m². In some instances, the DHC may be less than or equal to about 300 g/m², less than or equal to about 290 g/m², less than or equal to about 270 g/m², less than or equal to about 250 g/m², less than or equal to about 225 g/m², less than or equal to about 200 g/m², less than or equal to about 175 g/m², less than or equal to about 150 g/m², less than or equal to about 125 g/m², or less than or equal to about 70 g/m². Combinations of the above-referenced ranges are also possible (e.g., a DHC of greater than about 70 g/m² and less than or equal to about 290 g/m²). Other values of dust holding capacity are also possible. The above ranges of DHC can be determined by either the Palas test or the Multipass test.

The fiber web described herein may be used as filter media for the filtration of various particle sizes. In a typical test for measuring efficiency of a layer or the entire media (e.g., according to the Palas test or the Multipass test described above), particle counts at the particle size, x, selected upstream and downstream of the layer or media can be taken every minute. For the Palas test, the particle counts measured at 1 minute after the beginning of the test are used to calculate an initial efficiency value for a selected particle size. For the Multipass test, the particle counts are measured every minute until the terminal pressure is reached, and the values are averaged over the time of the test to obtain an overall efficiency value for a selected particle size. Generally, a particle size of x means that x micron or greater particles will be captured by the layer or media at the given efficiency levels. The average of upstream and downstream particle counts can be taken at the selected particle size. From the average particle count upstream (injected−C₀) and the average particle count downstream (passed thru −C) the filtration efficiency test value for the particle size selected can be determined by the relationship [(100−[C/C₀])*100%].

The coated fiber web may have a relatively high efficiency. The efficiency of the coated fiber web may be greater than or equal to about 90%, greater than or equal to about 92%, greater than or equal to about 94%, greater than or equal to about 96%, greater than or equal to about 98%, greater than or equal to about 99%, greater than or equal to about 99.5%, or greater than or equal to about 99.9%. In some instances, the efficiency of the coated fiber web may be less than or equal to about 99.99%, less than or equal to about 99.5%, less than or equal to about 98%, less than or equal to about 96%, less than or equal to about 94%, or less than or equal to about 92%. Combinations of the above-referenced ranges are also possible (e.g., greater than or equal to about 80% and less than or equal to about 99.99%). Other values of the efficiency of the coated fiber web are also possible. The above ranges of efficiency can be determined by either the Palas test or the Multipass test. In a Palas test, the efficiencies may be achieved for particle sizes x, in microns, where x may be, for example, 0.237, 0.274, 0.316, 0.365, 0.422, 0.487, 0.562, 0.649, 0.75, 0.866, 1, 1.155, 1.334, 1.54, 1.778, or 2.054. In a Multipass test, the efficiencies may be achieved for particle sizes x, where x may be, for example, 4, 5, 7, 10, 15, 20, 25, or 30 microns. In some embodiments for the Multipass test, x is 10 microns such that the above ranges of efficiency are suitable for filtering out 10 micron or larger particles.

In some embodiments, the coated fiber web may have a relatively high initial efficiency (as measured by the Palas test). The initial efficiency of the coated fiber web may be greater than or equal to about 90%, greater than or equal to about 92%, greater than or equal to about 94%, greater than or equal to about 96%, greater than or equal to about 98%, greater than or equal to about 99%, greater than or equal to about 99.5%, or greater than or equal to about 99.9%. In some instances, the initial efficiency of the coated fiber web may be less than or equal to about 99.99%, less than or equal to about 99.5%, less than or equal to about 98%, less than or equal to about 96%, less than or equal to about 94%, or less than or equal to about 92%. Combinations of the above-referenced ranges are also possible (e.g., greater than or equal to about 80% and less than or equal to about 99.99%). Other values of the initial efficiency of the coated fiber web are also possible. The initial efficiencies may be achieved for particle sizes x, in microns, as described above.

In some embodiments, the coated fiber web may have a mean flow pore size of greater than or equal to about 0.1 micron, greater than or equal to about 1 microns, greater than or equal to about 10 microns, greater than or equal to about 25 microns, greater than or equal to about 40 microns, greater than or equal to about 50 microns, greater than or equal to about 60 microns, greater than or equal to about 70 microns, or greater than or equal to about 80 microns. In some instances, the coated fiber web may have an average mean flow pore size of less than or equal to about 100 microns, less than or equal to about 80 microns, less than or equal to about 70 microns, less than or equal to about 60 microns, less than or equal to about 50 microns, less than or equal to about 35 microns, less than or equal to about 15 microns, less than or equal to about 5 microns, or less than or equal to about 0.5 microns. Combinations of the above-referenced ranges are also possible (e.g., greater than or equal to about 1 micron and less than or equal to about 50 microns). Other values of average mean flow pore size are also possible. The mean flow pore size may be determined according to the standard ASTM E1294 (2008) (M.F.P.).

In some embodiments, before coating the fiber web, the fiber web may be formed using a wet strength resin (e.g., a binder resin). The wet strength resin is not in fiber form and is to be distinguished from a binder fiber (e.g., multi-component fiber). In general, the wet strength resin may have any suitable composition. For example, the wet strength resin may comprise a polyacrylamide, epichlorohydrin, urea formaldehyde, melamine formaldehyde or a combination thereof. Other resins are also possible.

The amount of wet strength resin in the fiber web may vary. For instance, in some embodiments, the weight percentage of wet strength resin in the fiber web may be greater than or equal to about 0.5 wt %, greater than or equal to about 2 wt %, greater than or equal to about 5 wt %, greater than or equal to about 10 wt %, greater than or equal to about 20 wt %, greater than or equal to about 25 wt %, greater than or equal to about 30 wt %, greater than or equal to about 35 wt %, or greater than or equal to about 40 wt %. In some cases, the weight percentage of wet strength resin in the fiber web may be less than or equal to about 45 wt %, less than or equal to about 40 wt %, less than or equal to about 35 wt %, less than or equal to about 30 wt %, less than or equal to about 25 wt %, less than or equal to about 20 wt %, less than or equal to about 15 wt %, less than or equal to about 10 wt %, or less than or equal to about 2 wt %. Combinations of the above-referenced ranges are also possible (e.g., a weight percentage of wet strength resin of greater than or equal to about 5 wt % and less than or equal to about 35 wt %). Other ranges are also possible.

The wet strength resin may be added to the fibers in any suitable manner including, for example, in the wet state. In some embodiments, the wet strength resin coats the fibers and is used to adhere fibers to each other to facilitate adhesion between the fibers. Any suitable method and equipment may be used to coat the fibers, for example, using curtain coating, gravure coating, melt coating, dip coating, knife roll coating, or spin coating, amongst others. In some embodiments, the wet strength resin is precipitated when added to the fiber blend. When appropriate, any suitable precipitating agent (e.g., Epichlorohydrin, fluorocarbon) may be provided to the fibers, for example, by injection into the blend. In some embodiments, upon addition to the fiber blend, the wet strength resin is added in a manner such that the layer is impregnated with the wet strength resin (e.g., the wet strength resin permeates throughout the layer). In a multi-layered web, a wet strength resin may be added to each of the layers or to only some of the layer separately prior to combining the layers, or the wet strength resin may be added to the layers after combining the layers. In some embodiments, wet strength resin is added to the fiber blend while in a dry state, for example, by spraying or saturation impregnation, or any of the above methods. In other embodiments, a wet strength resin is added to a wet layer.

In some embodiments, a wet strength resin may be added to the fiber web by a solvent saturation process. In certain embodiments, a polymeric material can be impregnated into the fiber web either during or after the fiber web is being manufactured on a papermaking machine. For example, during a manufacturing process described herein, after the fiber web is formed and dried, a polymeric material in a water based emulsion or an organic solvent based solution can be adhered to an application roll and then applied to the article under a controlled pressure by using a size press or gravure saturator. The amount of the polymeric material impregnated into the fiber web typically depends on the viscosity, solids content, and absorption rate of fiber web. As another example, after the fiber web is formed, it can be impregnated with a polymeric material by using a reverse roll applicator following the just-mentioned method and/or by using a dip and squeeze method (e.g., by dipping a dried filter media into a polymer emulsion or solution and then squeezing out the excess polymer by using a nip). A polymeric material can also be applied to the fiber web by other methods known in the art, such as spraying or foaming.

A fiber web described herein may be produced using any suitable processes, such as using a wet laid process (e.g., a process involving a pressure former, a rotoformer, a fourdrinier, a hybrid former, or a twin wire process) or a non-wet laid process (e.g., a dry laid process, an air laid process, a meltblown process, an electrospinning process, a centrifugal spinning process, or a carding process). In some embodiments, the fiber web is formed using a process that results in a non-woven web. In other embodiments, the fiber web may be woven. Generally, fibers in a non-woven web are randomly entangled together, whereas fibers in a woven web are ordered.

In general, a wet laid process for forming a fiber web involves mixing together of fibers of one or more type to provide a fiber slurry. The slurry may be, for example, an aqueous-based slurry. In certain embodiments, the various fibers are optionally stored separately, or in combination, in various holding tanks prior to being mixed together (e.g., to achieve a greater degree of uniformity in the mixture). For instance, a first fiber may be mixed and pulped together in one container and a second fiber may be mixed and pulped in a separate container. The first fibers and the second fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture.

In certain embodiments, a fiber web described herein may include a multi-phased structure that may be formed by a wet laid process. For example, a first dispersion (e.g., a pulp) containing fibers in a solvent (e.g., an aqueous solvent such as water) can be applied onto a wire conveyor in a papermaking machine (e.g., a fourdrinier or a rotoformer) to form a first phase supported by the wire conveyor. A second dispersion (e.g., another pulp) containing fibers in a solvent (e.g., an aqueous solvent such as water) may be applied onto the first phase either at the same time or subsequent to deposition of the first phase on the wire. Vacuum is continuously applied to the first and second dispersions of fibers during the above process to remove the solvent from the fibers, thereby resulting in an article containing first and second phases. The article thus formed may then be dried and, if necessary, further processed (e.g., calendered) by using known methods to form a multi-phased fiber web. In some embodiments, such a process may result in a gradient in at least one property across the thickness of the phases. In other embodiments, a gradient in at least one property across the thickness of the phases may be produced by forming the phases separately and adhering (e.g., by laminating) the phases together.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, the wet laid process uses similar equipment as in a conventional papermaking process, for example, a hydropulper, a former or a headbox, a dryer, and an optional converter. A fiber web can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of fiber is in a suitable range, such as for example, between about 0.1% to 0.5% by weight.

Wet laid processes may be particularly suitable for forming a multi-phased structure within a fiber web, or for combining fiber webs, as described herein. For instance, in some cases, the same slurry is pumped into separate headboxes to form different phases within a fiber web. For laboratory samples, a first phase can be formed from a fiber slurry, drained and dried and then a second phase can be formed on top from a fiber slurry. In other embodiments, one phase can be formed and another phase can be formed on top, drained, and dried.

In some cases, the pH of the fiber slurry may be adjusted as desired. For instance, fibers of the slurry may be distributed under generally neutral conditions.

In some embodiments, a non-wet laid process is used to form the fiber web. For example, in a non-wet laid process, an air laid process or a carding process may be used. For example, in an air laid process, fibers may be mixed while air is blown onto a conveyor, and a binder is then applied. In a carding process, in some embodiments, the fibers are manipulated by rollers and extensions (e.g., hooks, needles) associated with the rollers prior to application of the binder. In some cases, forming the fiber web through a non-wet laid process may be more suitable for the production of a highly porous media. The non-wet fiber web may be impregnated (e.g., via saturation, spraying, etc.) with any suitable wet strength resin, as discussed above.

During or after formation of a fiber web, and after applying a coating to the fiber web as described herein, the coated fiber web may be further processed according to a variety of known techniques. Optionally, additional fiber webs (e.g., layers) can be formed and/or added to a coated fiber web using processes such as lamination, thermo-dot bonding, ultrasonic, calendering, glue-web, co-pleating, or collation. For example, in some cases, two fiber webs are formed into a composite article by a wet laid process as described above, and the composite article is then combined with another fiber web by any suitable process (e.g., lamination, co-pleating, or collation). In certain embodiments, lamination may be used to attach two or more separately formed phases or layers.

In some embodiments, further processing may involve pleating the fiber web. For instance, two fiber webs may be joined by a co-pleating process. In some cases, the fiber web, or various layers thereof, may be suitably pleated by forming score lines at appropriately spaced distances apart from one another, allowing the fiber web to be folded. It should be appreciated that any suitable pleating technique may be used.

In some embodiments, a fiber web can be post-processed such as subjected to a corrugation process to increase surface area within the web. In other embodiments, a fiber web may be embossed.

A fiber web described herein may be used in an overall filtration arrangement or filter element. In some embodiments, one or more additional layers or components are included with the fiber web (e.g., disposed adjacent to the fiber web, contacting one or both sides of the fiber web). In some embodiments, multiple fiber webs in accordance with embodiments described herein may be layered together in forming a multi-layer sheet for use in a filter media or element.

The fiber web can be incorporated into a variety of filter elements for use in various applications including hydraulic and non-hydraulic filtration applications Exemplary uses of hydraulic filters (e.g., high-, medium-, and low-pressure specialty filters) include mobile and industrial filters. Exemplary uses of non-hydraulic filters include air filters (e.g., heavy duty air filters, automotive air filters, HVAC filters, HEPA filters), fuel filters (e.g., ultra-low sulfur diesel), oil filters (e.g., lube oil filters or heavy duty lube oil filters), chemical processing filters, industrial processing filters, medical filters (e.g., filters for blood), fuel-water separators, and water filters. In some embodiments, a number of layers of fiber webs may be wrapped around an inner substrate (e.g., a synthetic or metal core) to form a wrapped filter. For example, a wrapped filter may include between 5 and 10 layers of fiber webs wrapped around the inner substrate. In some cases, the fiber web described herein can be used as filter media for coalescing applications (e.g., using a wrapped filter). For example, such a fiber web may be used to remove oil from compressed air.

The filter elements may have the same property values as those noted above in connection with the fiber web. For example, the above-noted tensile strength, Mullen Burst strength, elongation, air permeability, dust holding capacities, efficiencies of the fiber web may also be found in filter elements. In some embodiments, each layer of the filter element has the above-noted tensile strength, Mullen Burst strength, elongation, air permeability, dust holding capacity, and/or efficiency values described herein for the fiber web. In certain embodiments, the filter element may have substantially the same weight percentage of fibers as the fiber web (e.g., less than or equal to about 5 wt %, less than or equal to about 3 wt %, less than or equal to about 2 wt %, or less than 1 wt % thermoplastic binder fibers and/or fibrillated fibers.) In some embodiments, a filter element (e.g., hydraulic) formed of the webs may be free of additional support structures (e.g., a scrim).

During use, the fiber web mechanically traps particles on or in the layers as fluid flows through the fiber web. The fiber web need not be electrically charged to enhance trapping of contamination. Thus, in some embodiments, the fiber web is not electrically charged. However, in some embodiments, the fiber web may be electrically charged.

### EXAMPLES

### Example 1

A fiber web coated and cured with a resin containing Vylon GK680 (a copolyester, e.g., a first component) and epoxy/catalyst premix (e.g., a second component) was formed. The resulting fiber web had a higher dry tensile strength, dry Mullen Burst strength, and dry elongation at break, but substantially the same air permeability, thickness, and basis weight, compared to a fiber web that was coated with the epoxy/catalyst premix (Comparative Example 1).

The fiber web had a dual phase construction with a top phase and a bottom phase. The top phase was formed from about 39 wt % microglass fibers, about 20 wt % chopped strand fibers, about 40 wt % polyester fibers, and about 1 wt % poly(vinyl alcohol) binder fibers. The top phase had a basis weight of 41 g/m². The bottom phase was formed from about 58 wt % microglass fibers, about 40 wt % polyester fibers, and about 2 wt % poly(vinyl alcohol) binder fibers. The bottom phase had a basis weight of 81 g/m². Both phases were formed by a wet-laid process.

The coated fiber web had a basis weight of about 156 g/m², a thickness of about 31 mils, and an air permeability of about 27 CFM. The coated fiber web had an average dry MD tensile strength of about 22 lb/in, a dry MD elongation at break of about 11.8%, and a dry Mullen Burst strength of about 51 psi.

The resin contained Vylon GK680 and an epoxy/catalyst premix. Vylon GK680 is a copolyester with a Mₙ of 6,000 g/mol, Tg of 10° C., OH number of 21, and an acid number of less than 2. The epoxy/catalyst premix was a mixture of Dow DER 331 liquid epoxy resin and two initiators, dicyandiamide and 2-methylimidazole. The resin coating was formed by first preparing a 50 wt % solution of Vylon GK 680 in acetone. Then, a 2 wt % solution of dicyandiamide in methanol and a 2 wt % solution of 2-methylimidazole in methanol were prepared. To form the epoxy/catalyst premix solution, the 2 wt % solution of dicyandiamide in methanol, the 2 wt % solution of 2-methylimidazole in methanol, and Dow DER 331, which is 100 wt % solids, were added together. The resulting epoxy/catalyst premix solution contained 0.12 wt % dicyandiamide, 0.01 wt % 2-methylimidazole, and 9.87 wt % Dow DER 331. The 50 wt % solution of Vylon GK 680 was added to the epoxy/catalyst premix solution, such that the ratio of the Vylon GK 680 to the epoxy/catalyst premix solution was 9:1 by weight. Additional acetone was added to attain a solution with 5 wt % resin solids and 570 mL of acetone. Vylon GK 680 solids were 90 wt % of the resin solids and epoxy/catalyst premix solids were 10 wt % of the resin solids. The resin was then mixed until homogeneous.

The fiber web was coated by dipping the fiber web into a bath containing the resin. Excess resin was removed from the fiber web by passing the web through a 28 mils gap between two rolls. The coated web was air dried for 30 minutes and completely dried in an oven at 105° C. for 60 minutes to remove any residual acetone. The resin constituted about 22 wt % of the entire fiber web. The coated fiber web was then cured in a Mathis oven for 16 minutes at 195° C.

The coated fiber web had a 57% increase in dry tensile strength (MD), a 136% increase in dry elongation at break (MD), a 46% increase in dry Mullen Burst strength, and substantially the same air permeability compared to the coated fiber web described in Comparative Example 1.

### Comparative Example 1

A fiber web with a similar composition as Example 1 was formed, where the top phase was the same as that of Example 1, but the bottom phase differed slightly with respect to the weight percentages of microglass fibers and binder fibers. The bottom phase was formed from about 58 wt % microglass fibers, 40 wt % polyester fibers, and 2 wt % poly(vinyl alcohol) binder fibers. The fiber web was coated using a similar process as that described in Example 1, except the resin contained only the epoxy/catalyst premix.

The thickness, basis weight, and air permeability of the fiber web were substantially similar to those of the fiber web of Example 1; however, the dry tensile strength (MD), elongation at break (MD), and a dry Mullen Burst strength were lower. The fiber web had a dry tensile strength (MD) of about 14 lb/in, a dry elongation at break (MD) of about 5%, and a dry Mullen Burst strength of about 35 psi.

### Example 2

A fiber web with a similar composition as that described in Example 1 was formed using the process described in Example 1, except the coated fiber web was cured for 30 seconds instead of 16 minutes. The resulting fiber web had a higher dry elongation at break, but substantially the same air permeability, thickness, and basis weight, compared to the values for the fiber web of Comparative Example 1.

The coated fiber web had an average dry MD elongation at break of about 16.6, a dry MD tensile strength of about 18 lb/in and a dry Mullen Burst strength of about 50 psi.

The coated fiber web had a 232% increase in dry MD elongation at break and substantially the same air permeability compared to the coated fiber web described in Comparative Example 1.

### Example 3

A fiber web with a similar composition as that described in Example 1 was formed using the process described in Example 1, except the resin contained Vylon GK810 instead of Vylon GK680 and the coated fiber web was cured for 2 minutes. The resulting fiber web had a higher dry tensile strength, dry Mullen Burst strength, and dry elongation at break, but substantially the same air permeability, thickness, and basis weight, compared to Comparative Example 1.

Vylon GK810 is a copolyester with a Mₙ of 6,000 g/mol, Tg of 46° C., OH number of 19, and an acid number of 5.

The coated fiber web had an average dry MD tensile strength of about 28.7 lb/in and a dry Mullen Burst strength of about 37 psi. The coated fiber web had a 105% increase in dry tensile strength (MD), a 6% increase in dry Mullen Burst strength, and substantially the same air permeability compared to the coated fiber web described in Comparative Example 1.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1-3. (canceled)

4. An article, comprising:
a non-woven web comprising a plurality of glass fibers; and
a coating that coats at least a portion of the non-woven web, wherein the coating comprises a reaction product of a first component and a second component,
wherein the first component is a polymer having a glass transition temperature of less than or equal to about 60° C.

5. An article, comprising:
a non-woven web comprising a plurality of glass fibers; and
a coating that coats at least a portion of the non-woven web, wherein the coating comprises a reaction product of a first component and a second component,
wherein the first component is a linear polymer having a number average molecular weight of greater than 3,000 g/mol.

6. An article, comprising:
a non-woven web comprising a plurality of glass fibers; and
a coating that coats at least a portion of the non-woven web, wherein the coating comprises a reaction product of a first component and a second component,
wherein the first component is a selected from the group consisting of polyacrylates, polyurethanes, polycarbonates, saturated polyesters, unsaturated polyesters, polyterpenes, furan polymers, polyfurfural alcohol, polyamides, polyimides, polyamidimides, polyamidoamines, copolymers thereof, and combinations thereof.

7-9. (canceled)

10. The article of claim 4, wherein the non-woven web is a single layer or phase.

11. The article of claim 4, wherein the non-woven web includes more than one layer or phase.

12. The article of claim 4, wherein the non-woven web has a tensile strength in the machine direction of greater than or equal to about 5 lb/in and less than or equal to about 100 lb/in.

13. The article of claim 4, wherein the non-woven web has a Mullen burst strength of greater than or equal to about 10 psi and less than or equal to about 200 psi.

14. The article of claim 4, wherein the non-woven web has a dry elongation at break in the machine direction of greater than or equal to about 3% and less than or equal to about 40%.

15. The article of claim 4, wherein the non-woven web has a dry elongation at break in the machine direction of greater than or equal to about 3% and less than or equal to about 20%.

16. The article of claim 4, wherein the coating is formed using a non-aqueous based resin.

17. The article of claim 4, wherein the coating is formed by forming a polymer of the second component and reacting the first component with the polymer of the second component.

18. The article of claim 4, wherein the coating is formed by dissolving the first component in an organic solvent.

19. The article of claim 4, wherein the coating is formed by dissolving the first and second components in an organic solvent.

20. The article of claim 4, wherein the first component is a copolymer.

21. The article of claim 20, wherein the copolymer is a copolyester.

22. The article of claim 4, wherein the non-woven web comprises a first phase and a second phase.

23. The article of claim 4, wherein a total weight percentage of glass fibers in the non-woven web is greater than or equal to about 10 wt % and less than or equal to about 95 wt %.

24. The article of claim 4, wherein the second component is a monomer.

25. The article of claim 24, wherein the second component is an epoxy monomer.

26. The article of claim 4, wherein the first component has an OH number of greater than or equal to about 2 and less than or equal to about 60.

27. The article of claim 4, wherein the first component has an acid number of greater than or equal to about 0 and less than or equal to about 10.

28. The article of claim 4, wherein the second component is a selected from the group consisting of mono-epoxides, poly-epoxides, terpene phenolics, bismaleimides, cyanate esters, methylol melamine, methylol urea, isocyanate resins, methylol adducts of organic bases such as dicyandiamide, guanidine, guanylurea, biuret, triuret, and combinations thereof.

29. The article of claim 4, wherein the first component has a number average molecular weight of greater than or equal to about 3,000 g/mol and less than or equal to about 40,000 g/mol.

30. The article of, wherein the first component has a glass transition temperature of greater than or equal to about 15° C. and less than or equal to about 60° C.

31. The article of claim 4, where in the second component has a number average molecular weight of less than 3,000 g/mol.
